(19) United States
(12) Patent Application Publication
(10) Pub. No.: US 2025/0238874 A1
(43) Pub. Date: Jul. 24, 2025

(54) MACHINE LEARNING USER INTERFACE BASED FORM QUERY RESPONSE

(71) Applicant: ADP, Inc., Roseland, NJ (US)

(72) Inventors: Yongmei Jia, Basking Ridge, NJ (US); Philip Andrew Houston, Wharton, NJ (US)

(73) Assignee: ADP, Inc., Roseland, NJ (US)

(21) Appl. No.: 19/033,310

(22) Filed: Jan. 21, 2025

Related U.S. Application Data
(60) Provisional application No. 63/623,670, filed on Jan. 22, 2024.

(51) Int. Cl. G06Q 40/12; G06F 16/248

(52) U.S. Cl. CPC G06Q 40/123; G06F 16/248

(57) ABSTRACT

The technical solutions of the present disclosure are directed to providing validated responses to form specific user queries using machine learning. A system can include a processor to receive, via a user interface, a query corresponding to an entry of a form and identify a data structure. The processor can generate, using the data structure, a prompt to validate the entries and identify, based on the prompt and the data structure input a ML model, an error in an entry of the plurality of entries of the form. The processor can generate, based on the error and the data structure input into the ML model, a response to the query comprising a proposed correction to the error in the form, and provide, for display via the user interface, the response to the query indicating the error and the proposed correction.

### CROSS-REFERENCES TO RELATED APPLICATIONS

This application claims the benefit of priority under 35 U.S.C. § 119 to U.S. Provisional Patent Application No. 63/623,670, filed Jan. 22, 2024, which is hereby incorporated by reference herein in its entirety.

### TECHNICAL FIELD

This patent application generally relates to computing technology, particularly machine learning based document analysis solutions, and more particularly to technical solutions for machine learning based user interface responses to form queries.

### BACKGROUND

As the formats and volume of electronic forms executed by computing systems increase, it can be challenging to maintain compatibility of such forms with various processing engines without introducing excessive computing resource utilization, delays, or network latencies.

### SUMMARY

Technical solutions described herein utilize machine learning (ML) to provide validated responses to user queries across various electronic forms and their entries. Providing reliable and timely responses to electronic form inquiries concerning specific users and enterprises spanning different geographical areas can be a challenge. As individuals or enterprises associated with forms queries may be located in various areas and therefore subject to different jurisdictions, the responses to some of the form questions may vary based on the geographical area or other features associated with the user or the enterprise. Since laws and regulations impacting form execution can change over time subject to changes to local, regional or country legislature, some of the answers to various form queries may change. These changes can impact the ability of a system to accurately and reliably respond to the electronic form queries, thereby introducing errors, hindering the user experience, wasting the compute and network resources, and impacting the system energy efficiency.

The technical solutions of this disclosure can overcome these challenges by providing validated responses to form specific user queries using ML framework. The technical solutions of this disclosure utilize data structures indicative of entries of a form inquired by a user and generate a prompt for validating the entries. The technical solutions can utilize trained ML models to identify any errors in the entries of the form and generate a query response with proposed corrections to such errors. By displaying a validated response via a user interface, the technical solutions can improve the user experience, while conserving the processing and network resources and improving the system reliability and energy efficiency.

An aspect of the technical solutions of this disclosure relates to a system. The system can include a data processing system comprising one or more processors coupled with memory. The one or more processors can be configured (e.g., via instructions or data stored in the memory) to receive, via a user interface, a query corresponding to an entry of a form. The one or more processors can be configured to identify a data structure indicative of a plurality of entries of the form. The one or more processors can be configured to generate, using the data structure, a prompt to validate the plurality of entries. The one or more processors can be configured to identify, based on the prompt and the data structure input into one or more ML models trained using a dataset comprising a plurality of queries for a plurality of forms having a plurality of entries, an error in an entry of the plurality of entries of the form. The one or more processors can be configured to generate, based on the error and the data structure input into the one or more ML models, a response to the query comprising a proposed correction to the error in the form. The one or more processors can be configured to provide, for display via the user interface, the response to the query indicating the error and the proposed correction.

The one or more processors can be configured to validate, based at least on the proposed correction, the entry and the data structure input into the one or more ML models, the response. The one or more processors can be configured to provide, responsive to the validation, the response for display via the user interface. The one or more processors can be configured to receive the query via an application programming interface (API) call generated responsive to a request from a client device for an explanation of a value of the entry of the form for a payroll process. The one or more processors can be configured to generate, responsive to the API call, the response comprising text corresponding to the value of the entry of the form. The form can correspond to one of: a Form W-2, Wage and Tax Statement, a Form W-3, Transmittal of Wage and Tax Statements, or Form W-4, Employee's Withholding Certificate.

The one or more processors can be configured to identify, within the form for a tax operation, a plurality of entries comprising the entry, the plurality of entries corresponding to tax data associated with an electronic account of one of an enterprise or an employee of the enterprise. The one or more processors can be configured to generate, based on the form, the data structure indicating a plurality of values for the plurality of entries. The data structure is configured as a JavaScript object notation (JSON) object for input into the one or more ML models.

The one or more processors can be configured to receive the form comprising the entry corresponding to at least one of: a name of an enterprise, a name of one of an employee or a contractor, an address, an amount of annual income, an amount of tax deduction, an amount of tax credit, or an amount of tax withheld. The one or more processors can be configured to generate the response identifying the error in the entry of the form. The one or more processors can be configured to display, via the user interface, the query followed by the response comprising the proposed correction.

An aspect of the technical solutions of this disclosure is directed to a method. The method can include receiving, by one or more processors coupled with memory, via a user interface, a query corresponding to an entry of a form. The method can include identifying, by the one or more processors, a data structure indicative of a plurality of entries of the form. The method can include generating, by the one or more processors, using the data structure, a prompt to validate the plurality of entries. The method can include identifying, by the one or more processors, based on the prompt and the data structure input into one or more ML models trained using a dataset comprising a plurality of queries for a plurality of forms having a plurality of entries, an error in an entry of the plurality of entries of the form. The method can include generating, by the one or more processors, based on the error and the data structure input into the one or more ML models, a response to the query comprising a proposed correction to the error in the form. The method can include providing, by the one or more processors, for display via the user interface, the response to the query indicating the error and the proposed correction.

The method can include validating, by the one or more processors, the response based at least on the proposed correction, the entry and the data structure input into the one or more ML models. The method can include providing, by the one or more processors, responsive to the validation, the response for display via the user interface. The method can include receiving, by the one or more processors, the query via an application programming interface (API) call generated responsive to a request from a client device for an explanation of a value of the entry of the form for a payroll process. The method can include generating, by the one or more processors, responsive to the API call, the response comprising text corresponding to the value of entry of the form. The form corresponds to one of: a Form W-2, Wage and Tax Statement, a Form W-3, Transmittal of Wage and Tax Statements, or Form W-4, Employee's Withholding Certificate.

The method can include identifying, by the one or more processors, within the form for a tax operation, the plurality of entries corresponding to tax data associated with an electronic account of one of an enterprise or an employee of the enterprise. The method can include generating, by the one or more processors, based on the form, the data structure indicating a plurality of values for the plurality of entries. The data structure is configured as a JSON object for input into the one or more ML models.

The method can include receiving, by the one or more processors, the form comprising the entry corresponding to at least one of: a name of an enterprise, a name of one of an employee or a contractor, an address, an amount of annual income, an amount of tax deduction, an amount of tax credit, or an amount of tax withheld. The method can include generating, by the one or more processors, the response identifying the error in the entry of the form. The method can include displaying, by the one or more processors, via the user interface, the query followed by the response comprising the proposed correction.

An aspect of the technical solutions of this disclosure is directed to a non-transitory computer-readable medium comprising instructions. The instructions, when executed by one or more processors, can cause the one or more processors to receive, via a user interface, a query corresponding to an entry of a form. The instructions, when executed by one or more processors, can cause the one or more processors to identify a data structure indicative of a plurality of entries of the form. The instructions, when executed by one or more processors, can cause the one or more processors to generate, using the data structure, a prompt to validate the plurality of entries. The instructions, when executed by one or more processors, can cause the one or more processors to identify, based on the prompt and the data structure input into one or more ML models trained using a dataset comprising a plurality of queries for a plurality of forms having a plurality of entries, an error in an entry of the plurality of entries of the form. The instructions, when executed by one or more processors, can cause the one or more processors to generate, based on the error and the data structure input into the one or more ML models, a response to the query comprising a proposed correction to the error in the form. The instructions, when executed by one or more processors, can cause the one or more processors to provide, for display via the user interface, the response to the query indicating the error and the proposed correction.

The instructions, when executed by one or more processors, can cause the one or more processors to validate, based at least on the proposed correction, the entry and the data structure input into the one or more ML models, the response. The instructions, when executed by one or more processors, can cause the one or more processors to provide, responsive to the validation, the response for display via the user interface.

The instructions, when executed by one or more processors, can cause the one or more processors to receive the query via an application programming interface (API) call generated responsive to a request from a client device for an explanation of a value of the entry of the form for a payroll process. The instructions, when executed by one or more processors, can cause the one or more processors to generate, responsive to the API call, the response comprising text corresponding to the value of the entry of the form, wherein form corresponds to one of: a Form W-2, Wage and Tax Statement, a Form W-3, Transmittal of Wage and Tax Statements, or Form W-4, Employee's Withholding Certificate. The data structure can be configured as a JSON object.

### BRIEF DESCRIPTION OF THE DRAWINGS

Aspects of the present disclosure are described in the detailed description which follows, in reference to the noted plurality of drawings by way of non-limiting examples of exemplary embodiments of the present disclosure.

FIG. 1 illustrates an example of a system for providing a machine learning user interface based form query responses.

FIG. 2 illustrates an example of a system for providing form inspection and responses to user queries relating the form using an ML model.

FIG. 3 illustrates an example form for analysis by an ML model.

FIG. 4 can illustrate an example prompt and a corresponding data structure (e.g., a JSON object) generated for the form.

FIG. 5 illustrates an example communication exchange between a user asking questions (e.g., queries) concerning the form and receiving responses from an ML model.

FIG. 6A illustrates an example of communication exchange between the user and the AI-model, via the user interface, on inconsistencies, or errors in the form.

FIG. 6B illustrates an example of communication exchange in which a user asks explanations on particular portions of the form and AI model provides responses explaining the requested portions of the form.

FIGS. 7A and 7B illustrate examples of communication exchanges generated and responded to by the ML models.

FIGS. 8A-10B, illustrate examples of systems using application-based user interface for searching data and responding to user queries using ML models.

FIG. 11 illustrates an example system 1100 for training or retraining the ML model of the technical solutions.

FIG. 12 illustrates a block diagram of a computing system for implementing the embodiments of the technical solutions, in accordance with embodiments.

FIG. 13 illustrates a flow diagram of a method for providing validated responses to form specific user queries using ML models.

### DETAILED DESCRIPTION

The technical solutions provide a user interface utilizing ML to generate responses to various electronic form-specific user inquiries for electronic forms concerning various regions, applications, or fields. Providing reliable, accurate, and timely responses to inquiries related to electronic forms whose entry execution can vary based on geographical regions having regulations, rules, and laws that may change at any time, remains a challenge. Industries, such as taxation, mortgage, or healthcare, which make use of complex electronic forms, are challenged to address queries on details of electronic forms. The systems used for populating information in such electronic forms and further executing such forms are error prone. For example, errors may be introduced due to unexpected form-related regulation changes across different jurisdictions as changes to laws, rules, or regulations across different regions or countries change the way some form parameters are computed. In such instances, unless timely updated, processing systems can produce outdated (e.g., erroneous) parameter computations, leading to processing and network resources waste and energy inefficiencies as these computational errors are corrected.

The technical solutions described herein provide a streamlined ML based solution that overcomes these challenges by receiving and processing the user queries and providing validated responses that identify and explain any errors in the relevant forms via query responses. The technical solutions can utilize data structures indicative of form entries and generate prompts for validating such entries using ML models. The technical solutions can identify any errors associated with the form entries and provide a proposed correction to such errors to include in the response provided to the user, thereby improving user experience, conserving the processing and network resources, and improving the system's overall reliability and energy efficiency.

The technical solutions herein can include systems and methods that utilize ML functionalities, such as trained generative artificial intelligence models, to implement validation and error detection of a user-provided filled-out form or any questions associated therewith. The forms can include any payroll related forms, such as, a U.S. federal tax Form W-2, Wage and Tax Statement, Form W-3, Transmittal of Wage and Tax Statements, or Form W-4, Employee's Withholding Certificate. While the example forms listed here are U.S.—based, the technical solutions described herein are not limited to U.S.—based forms, and can be applicable with forms from other countries. Further, the technical solutions described herein are not limited to federal/national level forms and apply to forms that may be from local governing bodies, such as state, county, city, municipality, or any other such jurisdiction. Further yet, the technical solutions described herein are not applicable only to government/public forms, but are also applicable to forms that may be provided by business organizations, non-profit organizations, unions, individuals, or any other entities.

The technical solutions can utilize ML models, for example, to identify potential discrepancies concerning form-related payroll operations, such as computations of specific values in the form entries. For example, a discrepancy may exist in a total annual income, annual taxable income, amount of tax deductions, or any other entries of an electronic form, where such entries are used in computations can be used for the completion of a payroll process. For instance, consider a tax form (e.g., W-2 form in the U.S.). A user can provide a series of inputs to populate the electronic tax form, and also user-generated questions related to the tax form and/or the process in which the tax form may be used. The receiving system can transmit the inputs, and questions to a ML model. The ML model can be trained to analyze and inspect the tax form for accuracy and identify any errors or potential discrepancies with any of the form entries (e.g., accuracy of the computed or entered values). In some examples, the ML model further provides user assistance, including error detection and proposed corrections. For example, the ML models can provide responses or answers to user-generated questions on the tax form or tax process.

For example, the technical solutions can include ML functionalities, such as a generative artificial intelligence model-based tax form inspection functionality, for analyzing filled-out tax forms for clients or their employees, and identifying errors, inconsistencies, or points of heightened concern. By leveraging such machine learning model capabilities, the technical solutions described herein can provide error detection and propose error corrections, streamlining the user interaction and the tax inspection process and improving the system efficiency, accuracy, and compliance. The technical solutions described herein can provide a tax assistance function to provide clients with automated machine learning model generated answers to user queries on particular tax form details. The technical solutions can allow users and clients to engage with the machine learning model to gain a deeper comprehension of the intricacies of tax forms, leading to improved understanding and informed decision-making.

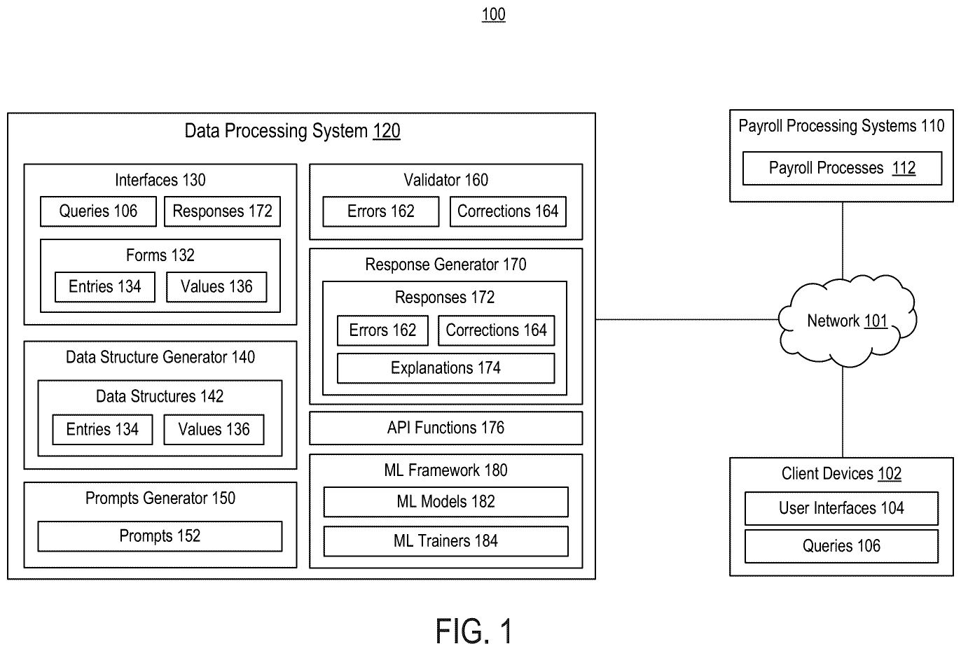

FIG. 1 illustrates an example system 100 for providing validated responses to form specific user queries using machine learning. Example system 100 can include one or more data processing systems 120 communicatively coupled with one or more client devices 102 and payroll processing systems 110, via one or more networks 101. A client device 102 can include one or more user interfaces 104 for receiving user generated queries 106 for the data processing system 120. A payroll processing system 110 can include and execute one or more payroll processes 112, such as employee or enterprise tax computations that may be utilized in connection with various forms 132.

A data processing system 120 can include, execute or provide one or more interfaces 130, data structure generators 140, prompts generators 150, validators 160, response generators 170, application programming interface (API) functions 176, or machine learning (ML) frameworks 180. An interface 130 of the data processing system 120 can include, identify or receive one or more queries 106 from the user interface 104 of the client device 102, and provide for transmission to the client device 102 one or more response 172 to such queries 106 upon their generation by the data processing system 120. The interface 130 can receive, identify or process one or more forms 132 having various entries 134 that can be populated by different values 136.

A machine learning framework 180 can include, generate, manage or provide one or more ML trainers 184 for training ML models 182 that can be utilized by any of the data structure generator 140, prompts generator 150, validator 160, and response generator 170 for performing their operations. A data structure generator 140 of the data processing system 120 can generate, manage, or identify one or more data structures 142, such as a JavaScript Object Notation (JSON) object, which can include or indicate various entries 134 and values 136 of the corresponding forms 132. A prompts generator 150 of the data processing system 120 can utilize one or more data structures 142 to generate one or more prompts 152, which can be used to validate the entries 134 (e.g., based on their values 136). A validator 160 of the data processing system 120 can utilize the prompts 152 and the data structures 142 to identify any errors 162 and generate or propose corrections 164 to such errors. A response generator 170 can construct or generate the responses 172 to provide to the client device 102. The responses 172 can include any errors 162 identified by the validator 160 as well as any proposed corrections 164 to such errors 162, along with any textual explanations 174 of any question in the queries 106, errors 162, or proposed corrections 164. An API function 176 of the data processing system 120 can receive, transmit, and manage any API calls or API responses between system components, such as the payroll processing system 110, client devices 102, and data processing system 120.

Client devices 102 can include any combination of hardware and software for interacting with data processing system 120 to provide queries 106 and receive responses 172. Client devices 102 can include computers, smartphones, tablets, or any other electronic devices capable of running applications and connecting via networks 101. Client devices 102 can include one or more user interfaces 104 for receiving user-generated queries 106 for the data processing system 120. For example, a user can use a smartphone to execute an application to submit a query about a payroll form via an application interface. Client devices 102 can communicate with the data processing system 120 and payroll processing systems 110 via a network 101. Client devices 102 can display responses 172 generated by the data processing system 120, providing users of the client devices 102 with validated information and proposed corrections 164 to any identified errors 162 in the queries 106.

User interfaces 104 can include any combination of hardware and software for facilitating user interaction with client devices 102. User interfaces 104 can include graphical user interfaces (GUIs), command-line interfaces (CLIs), or voice-activated interfaces. User interfaces 104 can receive user-generated queries 106 and transmit these queries 106 to the data processing system 120. For example, a GUI on a computer can allow a user to input a query 106 about an entry 134 on a tax related form 132. User interfaces 104 can display responses 172 from the data processing system 120, including any errors 162 identified and their corresponding proposed corrections 164. User interface 104 can include textual explanations 174 of any errors 162 identifies, any corrections 164 proposed, or any questions or issues raised in the query 106.

Queries 106 can be any form of user-generated requests for information or actions related to electronic forms 132. These queries 106 can be textual, voice-based, or in any other format that can be processed by the data processing system 120. Queries 106 can correspond to specific entries 134 of forms 132 and can be received via user interfaces 104. For example, a user can utilize a client device 102 to submit a query 106 asking for an explanation of a value 136 in a particular form 132 (e.g., a tax form, a payroll form, or a human resources processing form). Queries 106 can be processed by the data processing system 120 to generate responses 172 that address the user's request, including identifying any errors 162 and providing proposed corrections 164.

Payroll processing systems 110 can include any combination of hardware and software for managing payroll-related operations or processes. Payroll processing systems 110 can execute one or more payroll processes 112, such as employee or enterprise tax computations, salary calculations, benefits administration, overtime calculations, deductions management, direct deposit processing, payroll reporting, compliance with tax regulations, year-end tax form generation, and employee time tracking. Payroll processing systems 110 can be utilized in connection with various forms 132, such as tax forms or payroll statements. For example, a payroll processing system 110 can calculate the total annual income and tax deductions for an employee based on the entries 134 in a Form W-2. Payroll processing systems 110 can communicate with the data processing system 120 to provide the data for generating validated responses 172 to user queries 106.

Payroll processes 112 can include any combination of operations and computations related to payroll management. Payroll processes 112 can involve calculating employee salaries, tax deductions, and other payroll-related values 136. Payroll processes 112 can include, for example, employee tax computations, salary calculations, benefits administration, overtime calculations, deductions management, direct deposit processing, payroll reporting, compliance with tax regulations, year-end tax form generation, and employee time tracking. Payroll processes 112 can include, for example, calculating total annual income, determining federal tax withheld, computing state tax withheld, calculating Social Security wages, determining Medicare wages, computing additional Medicare tax, calculating dependent care benefits, determining retirement plan contributions, and generating year-end summaries for W-2, W-3, W-4, or other similar tax forms. Payroll processes 112 can be executed by payroll processing systems 110 and can utilize data from various forms 132. For example, a payroll process 112 can compute the amount of tax withheld based on the entries 134 in a Form W-4. These processes 112 can generate data that can be used by the data processing system 120 to validate user queries 106 and provide accurate responses 172.

Data processing system 120 can include any combination of hardware and software for processing data and generating responses 172 to user queries 106. Data processing system 120 can be deployed on a central server or across a distributed computing environment, such as one or more physical or virtual machines, or on a cloud-based system. The data processing system 120 can include, execute, or provide one or more interfaces 130, data structure generators 140, prompts generators 150, validators 160, response generators 170, API functions 176, and ML frameworks 180. The data processing system 120 can receive queries 106 from client devices 102 and process them to generate responses 172. For example, the data processing system 120 can use ML models 182 to identify errors 162 in form entries 134 and generate proposed corrections 164. The data processing system 120 can utilize the ML modeling to generate responses 172 responsive to any user queries 106 to improve user experience by providing validated and accurate information.

Interfaces 130 can include any combination of hardware and software for facilitating communication between different components of the system 100. The interfaces 130 of the data processing system 120 can operate together or in conjunction with the user interfaces 104 of the client devices 102 allowing for seamless or continuous flow of information between the data processing system 120 and the client devices 102. The interfaces 130 can receive, identify, or process queries 106 from user interfaces 104 of client devices 102. Interfaces 130 can also transmit responses 172 generated by the data processing system 120 to client devices 102. For example, an interface 130 can receive a query 106 about a payroll form entry and forward it to the data processing system 120 for processing. Interfaces 130 can ensure seamless communication and data exchange within the system 100, including with payroll processing systems 110 and any of the payroll processes 112 that can be triggered, activated or utilized by the data processing system 120.

Forms 132 can include any electronic documents that can be generated, referenced or used by the data processing system 120, client device 102 or payroll processing system 110. The forms 132 can include any forms any payroll process 112, such as payroll, taxation, benefits enrollment, direct deposit authorization, time-off requests, expense reports, employee evaluations, compliance certifications, onboarding documents, and termination forms. Forms 132 can have various entries 134 that can be populated by different values 136, including any string of characters for filling up a form 132. For example, a Form W-2 can include entries 134 for employee name, annual income, and tax withheld, and values 136 can include the characters (e.g., letters or numbers) used to fill out such entries 134. Forms 132 can be processed by the data processing system 120 to validate user queries 106 and generate accurate responses 172.

Entries 134 can include any individual data fields within forms 132. These entries 134 can be populated by different values 136 and can correspond to specific data points. For example, an entry 134 in a payroll form can include the employee's annual income. Entries 134 can be identified and processed by the data processing system 120 to validate user queries 106. The data processing system 120 can use ML models 182 to identify any errors 162 in the entries 134 and generate proposed corrections 164.

Values 136 can include any characters that can be used to populate entries 134 in forms 132. The values 136 can include characters that are numerical, textual, symbolic (e.g., symbols), or of any other format relevant to the form 132. For example, a value 136 in a tax form entry 134 can be the amount of tax withheld. Values 136 can be processed by the data processing system 120, such as by utilizing one or more automated payroll processing systems 110 to implement specific payroll processes 112 to compute or validate user queries 106 and generate accurate responses 172. The data processing system 120 can use data structures 142 to manage and validate these values 136, ensuring data accuracy and reliability.

Data structure generator 140 can include any combination of hardware and software for generating and managing data structures 142. The data structures 142 can include or indicate various entries 134 and values 136 of the corresponding forms 132. The data structure generator 140 can utilize ML models 182 configured (e.g., trained or prompted) to generate data structures 142 along with the specific entries 134 or values 136. For example, a data structure generator 140 can create a data structure 142 that is a JSON object representing various entries 134 and values 136 of a payroll form 132. These data structures 142 can be used by other components of the data processing system 120, such as prompts generator 150 and validator 160, to validate form entries 134 and generate accurate responses 172.

Data structures 142 can include any organized format for storing and managing data. The data structures 142 can represent entries 134 and values 136 of forms 132. For example, a data structure 142 can be a JSON object that includes the entries 134 and values 136 of a tax form. Other than JSON objects, the data structures 142 can utilize or include XML (extensible Markup Language), YAML (YAML Ain't Markup Language), BSON (Binary JSON), MessagePack, Protocol Buffers (Protobuf), Avro, Thrift, CSV (Comma-Separated Values), Parquet, and ORC (Optimized Row Columnar). Data structures 142 can be generated by the data structure generator 140 and used by other components of the data processing system 120 to validate user queries 106.

Prompts generator 150 can include any combination of hardware and software for generating prompts 152 to validate form entries 134. The generated prompts 152 can be based on data structures 142 and can be used to identify any errors 162 in the entries 134. The prompts generator 150 can utilize ML models 182 configured (e.g., trained or prompted) to perform its functionalities, such as to generate the prompts 152. For example, prompts generator 150 can generate a prompt 152 to cross-check the federal tax withheld entry 134 against predefined tax brackets. Prompts generator 150 can create a prompt 152 to verify the consistency of the employee's name and address entries 134 with the corresponding values 136 in the database. Prompts generator 150 can generate a prompt 152 to validate the accuracy of the Social Security wages entry 134 by comparing it with the total annual income entry 134 or other values 136 of other entries 134. Prompts generator 150 can create a prompt 152 to ensure that the dependent care benefits entry 134 does not exceed the allowable limit set by regulations. Prompts generator 150 can generate a prompt 152 to check for any discrepancies in the retirement plan contributions entry 134 by comparing it with historical data. For example, a prompts generator 150 can create a prompt 152 to validate the annual income entry 134 in a payroll form. The prompts 152 can be used by the validator 160 to identify errors 162 and generate proposed corrections 164. Prompts generator 150 can improve the accuracy and reliability of the data processing system 120 by constructing prompts 152 that direct, instruct, or focus the operation of the prompts generator 150.

Prompts 152 can include any collections of data, requests, or instructions constructed or generated to instruct an ML model 182. A prompt 152 can include instructions or data to direct one or more ML models 182 to validate one or more entries 134 of a form 132. The prompts 152 can be based on data structures 142 and can be used to identify errors 162 in the entries 134. The prompts 152 can be generated by the ML models 182 based on the prompts generator 150 utilizing the ML models 182 to generate the prompts 152 per configuration (e.g., training or instructions). For example, a prompt 152 can request validation of the tax withheld entry 134 in a tax form. Prompts 152 can be used by the validator 160 to identify errors 162 and generate proposed corrections 164. These prompts 152 can ensure accurate data validation and processing within the system 100.

Validator 160 can include any combination of hardware and software for validating form entries 134 based on prompts 152 and data structures 142. The validator 160 can identify any errors 162 in the entries 134 and generate proposed corrections 164. The validator 160 can implement its functionalities using one or more ML models 182 that can be configured (e.g., trained or prompted) to perform such functionalities. The validator 160 can, for example, utilize an ML model 182 to evaluate a particular entry 134 by using an API function 176. The ML models 182 can, for example, be trained to compute or validate different entries 134 of the forms 132 and identify any errors 162, proposed corrections 164, or explanations 174.

The validator 160 can utilize the ML models 182 along with payroll processing system 110 to validate or evaluate entries 134 of the forms 132. For instance, a validator 160 can use ML models 182 along with a prompt 152 to validate the annual income entry 134 in a payroll form 132 and identify any discrepancies (e.g., errors 162). The validator 160 can identify the discrepancies using ML model 182. The ML model 182 can identify the entries 134 and utilize API functions 176 to send API calls to the payroll processing system 110 to trigger processing or computation of the values 136 of the given entries 134 by the payroll processes 112 used for computing such entries 134. For instance, the ML model 182 can identify a tax withholding entry 134 and utilize a payroll processing system 110 to utilize a payroll process 112 that executes and computes the tax withholding entry 134 to check if the value 136 of the entry 134 on the tax withholding provided by the query 106 matches the output from the payroll process 112. If there is no match between the entry 134 (e.g., and its value 136) and the value 136 determined by the payroll process 112, the ML model 182 can determine that this given entry 134 of the form 132 is erroneous, generating or identifying an error 162. The ML model 182 can then utilize the same or different payroll processes 112 to check all the remaining entries 134. The validator 160 can then identify any of the errors 162 and propose corrections 164 for them. The corrections 164 can include, for example, the values that are considered correct, such as the values 136 of the entries 134 computed or verified by the payroll process 112 triggered by the validator 160 or its ML model 182.

The validator 160 can utilize ML models 182 to generate textual explanations 174 to any questions in the queries 106. For instance, a query 106 can include a question that may or may not involve any entries 134 of the form 132. The validator 160 can utilize the ML models 182 trained using data stored in the database 202 of example system 200 to provide responses 172 with explanations 174 to generate textual explanations responsive to the questions in the queries 106.

Errors 162 can include any discrepancies or inaccuracies identified in the entries 134 of a form 132. The errors 162 can include values 136 that are inconsistent with other values 136 of other entries 134 of the same or different form associated with a particular client account (e.g., profile or account associated with an entity, such as an employee or an enterprise associated with the form 132). The error 162 can be detected by the validator 160 based on prompts 152 and data structures 142. The error 162 can be detected based on the validator 160 using the ML model 182. The ML model 182 can be configured (e.g., trained or prompted) to evaluate all of the values 136 of all the entries 134 of the form 132 and identify any discrepancies. The ML model 182 can utilize payroll processes 112 implemented by the payroll processing system 110 to compute or determine any of the values 136 to any of the entries 134 of the form 132. The validator 160 can compare or match the values 136 of the entries 134 from the form 132 with those determined by the payroll processes 112 to identify or detect any differences or discrepancies. In response to identifying, determining or detecting any differences or discrepancies, the validator 160 can designate, identify or announce an error 162. For example, an error 162 can be an incorrect value 136 in the tax withheld entry 134 of a tax form. For example, an error 162 can be an incorrect Social Security wages value 136, an inaccurate Medicare wages value 136, a mismatched state tax withheld value 136, an erroneous dependent care benefits value 136, an incorrect retirement plan contributions value 136, a miscalculated additional Medicare tax value 136, an inaccurate total annual income value 136, a wrong federal tax withheld value 136, an incorrect amount of tax deductions value 136, or an erroneous amount of tax credits value 136 in the entries 134 of a tax form 132. Errors 162 can be addressed by generating proposed corrections 164, which can be included in the responses 172 provided to the user.

Proposed corrections 164 can include any suggested changes to address errors 162 in form entries 134. Corrections 164 can include the verified or corrected values 136 to replace the values 136 of the entries 134 that are identified as errors 162. The corrections 164 can be generated by the validator 160 based on prompts 152 and data structures 142, using for example, ML models 182. For example, a proposed correction 164 can be a revised value 136 for the annual income entry 134 in a payroll form. For example, a proposed correction 164 can be a revised value 136 for the federal tax withheld entry 134, an updated value 136 for the state tax withheld entry 134, a corrected value 136 for the Social Security wages entry 134, an adjusted value 136 for the Medicare wages entry 134, an accurate value 136 for the additional Medicare tax entry 134, a modified value 136 for the dependent care benefits entry 134, a revised value 136 for the retirement plan contributions entry 134, an updated value 136 for the total annual income entry 134, a corrected value 136 for the annual taxable income entry 134, or an adjusted value 136 for the amount of tax deductions entry 134 in a payroll form. Proposed corrections 164 can be included in the responses 172 provided to the user, along with explanations 174. Identifying and correcting errors 162 using proposed corrections 164 can improve data accuracy and user satisfaction and reduce consumption of system resources, while improving the system efficiency.

Response generator 170 can include any combination of hardware and software for generating responses 172 to user queries 106. Response generator 170 can utilize ML models 182 configured (e.g., trained or prompted) to generate the responses 172 that can include, indicate, state, or describe any errors 162, corrections 164 using any explanations 174. The response generator 170 can generate the responses 172 based on the validations made by the validator 160, including any errors 162 or their corresponding corrections. The responses 172 of the response generator 170 can include one or more errors 162 from a particular form 132 and any proposed corrections 164 for such one or more errors 162, along with any explanations 174. For example, a response generator 170 can create a response 172 to a query 106 about a tax form entry 134, including any identified errors 162 and proposed corrections 164. The responses 172 can be transmitted to client devices 102 via interfaces 130, providing users with validated and accurate information.

Responses 172 can include information provided to users in response to their queries 106. For example, the responses 172 can include identified errors 162, proposed corrections 164, and explanations 174. For example, a response 172 can include a corrected value 136 for a payroll form entry 134 and an explanation 174 of the correction. For example, a response 172 can include an error 162 in the federal tax withheld entry 134 with a proposed correction 164 and an explanation 174 of the error 162 and the correction 164 proposed. The response 172 can include an error 162 in the state tax withheld entry 134 with a proposed correction 164 and an explanation 174, an error 162 in the Social Security wages entry 134 with a proposed correction 164 and an explanation 174, an error 162 in the Medicare wages entry 134 with a proposed correction 164 and an explanation 174, an error 162 in the additional Medicare tax entry 134 with a proposed correction 164 and an explanation 174, an error 162 in the dependent care benefits entry 134 with a proposed correction 164 and an explanation 174, an error 162 in the retirement plan contributions entry 134 with a proposed correction 164 and an explanation 174, an error 162 in the total annual income entry 134 with a proposed correction 164 and an explanation 174, an error 162 in the annual taxable income entry 134 with a proposed correction 164 and an explanation 174, or an error 162 in the amount of tax deductions entry 134 with a proposed correction 164 and an explanation 174. Responses 172 can be generated by the response generator 170 and transmitted to client devices 102 via interfaces 130. These responses 172 can enhance user experience by providing accurate and validated information.

Explanations 174 can include any textual or graphical descriptions provided to users to clarify responses 172. These explanations 174 can address user queries 106, identified errors 162, and proposed corrections 164. For example, an explanation 174 can describe why a particular value 136 in a tax form entry 134 was corrected and how it was corrected. For example, the explanation 174 can include and/or describe which computations, operations, or processes were used for the corrections. Explanations 174 can be included in the responses 172 generated by the response generator 170 and transmitted to client devices 102. These explanations 174 can improve user understanding and satisfaction. In some examples, the explanations 174 are generated using generative AI.

API functions 176 can include any combination of hardware and software for managing API calls and responses between system components. API functions 176 can be utilized by the data structure generator 140, prompts generator 150, validator 160, or response generator 170 to call any of the functions, operations, or functionalities described herein and to receive responses. API functions 176 can make API calls and receive API responses to such calls from payroll processing system 110, client devices 102, ML framework 180, or any other feature on behalf of any data processing system 120 component. These functions 176 can facilitate communication between the data processing system 120, client devices 102, and payroll processing systems 110. For example, an API function 176 can receive a query 106 from a client device 102 and forward it to the data processing system 120 for processing. API functions 176 can ensure seamless data exchange and integration within the system 100.

ML frameworks 180 can include any combination of hardware and software for implementing any ML or artificial intelligence (AI) functionalities. The ML framework 180 can manage and provide ML trainers 184 for training ML models 182 and can provide, deploy, and retrain ML models 182 to perform functionalities on behalf of any data processing system 120 component (e.g., data structure generator 140, prompts generator 150, validator 160 and response generator 170). For example, an ML framework 180 can train an ML model 182 to identify errors 162 in payroll form entries 134 on behalf of a validator 160. ML frameworks 180 can be utilized by various components of the data processing system 120, such as a response generator 170, to generate responses 172 with explanations 174 on why and how errors 162 are to be corrected by proposed corrections 164.

ML models 182 can include any trained ML or AI algorithms used by the data processing system 120. ML models 182 can configured (e.g., trained or prompted) for any combination of data processing, data validation, identification of errors 162 or corrections 164 or generation of explanations 174. The ML models 182 can be trained using datasets comprising queries 106 and form entries 134. For example, an ML model 182 can be trained to identify errors 162 in tax form entries 134 and generate proposed corrections 164. ML models 182 can be utilized by the data processing system 120 to validate user queries 106 and generate accurate responses 172. The ML models 182 can enhance the accuracy and reliability of the system 100.

The ML models 182 can include any combination of one or more neural networks, decision-making models, linear regression models, natural language models, random forests, classification models, generative AI models, reinforcement learning models, clustering models, neighbor models, decision trees, probabilistic models, classifier models, or other such models. For example, the models 182 include natural language processing (e.g., support vector machine (SVM), Bag of Words, Counter Vector, Word2Vec, k-nearest neighbors (KNN) classification, long short erm memory (LSTM)), object detection and image identification models (e.g., mask region-based convolutional neural network (R-CNN), CNN, single shot detector (SSD), deep learning CNN with Modified National Institute of Standards and Technology (MNIST), RNN based long short term memory (LSTM), Hidden Markov Models, You Only Look Once (YOLO), LayoutLM) (classification ad clustering models (e.g., random forest, XGBBoost, k-means clustering, DBScan, isolation forests, segmented regression, sum of subsets 0/1 Knapsack, Backtracking, Time series, transferable contextual bandit) or other models such as named entity recognition, term frequency-inverse document frequency (TF-IDF), stochastic gradient descent, Naïve Bayes Classifier, cosine similarity, multi-layer perceptron, sentence transformer, data parser, conditional random field model, Bidirectional Encoder Representations from Transformers (BERT), among others.

The ML models 182 can include generative AI models 182, which can include any machine learning systems configured to create new content, such as text, images, or audio, by learning patterns from the data stored in the database 202 (e.g., training datasets). The generative AI models 182 can be trained using techniques such as supervised learning, unsupervised learning, and reinforcement learning. Generative AI models 182 can utilize a data set from the stored data to create logical inferences between various complex structures in the data set to generate coherent outputs for prompts input into the models 182.

The ML models 182 implemented as generative AI models can include any machine learning (ML) or artificial intelligence (AI) model designed to generate content or new content, such as text, images, or code, by learning patterns and structures from existing data. Such generative AI model 182 can be any model, a computational system or an algorithm that can learn patterns from data (e.g., chunks of data from various input documents, computer code, templates, forms, etc.) and make predictions or perform tasks without being explicitly programmed to perform such tasks. The generative AI model 182 can refer to or include a large language model. The generative AI model 182 can be trained using a dataset of documents (e.g., text, images, videos, audio or other data). The generative AI model 182 can be designed to understand and extract relevant information from the dataset. The generative AI model 182 can leverage natural language processing techniques and pattern recognition to comprehend the context and intent of the prompt (e.g., instruction), which can be used as input into the ML model 182.

The generative AI model 182 can be built using deep learning techniques, such as neural networks, and can be trained on large amounts of data. The generative AI model 182 can be designed, constructed, or include a transformer architecture with one or more of a self-attention mechanism (e.g., allowing the model to weigh the importance of different words or tokens in a sentence when encoding a word at a particular position), positional encoding, encoder and decoder (multiple layers containing multi-head self-attention mechanisms and feedforward neural networks). For example, each layer in the encoder and decoder can include a fully connected feed-forward network, applied independently to each position. The data processing system 120 can apply layer normalization to the output of the attention and feed-forward sub-layers to stabilize and improve the speed with which the generative AI model 182 is trained. The data processing system 120 can leverage any residual connections to facilitate preserving gradients during backpropagation, thereby aiding in the training of the deep networks. Transformer architecture can include, for example, a generative pre-trained transformer, a bidirectional encoder representations from transformers, transformer-XL (e.g., using recurrence to capture longer-term dependencies beyond a fixed-length context window), text-to-text transfer transformer,

The generative AI model 182 can be trained (e.g., by a model training function) using any text-based dataset by converting the text data from the input dataset documents into numerical representations (e.g., embeddings) of the chunks of those documents. For example, the dataset can include various tax forms such as Form W-2, Form W-3, and Form W-4, which contain entries related to employee income, tax withholdings, and other payroll-related data. The model can be trained to understand the specific terminology and structure of these tax forms to accurately identify and correct errors. These embeddings can capture the semantic meaning of words, paragraphs, pages or sentences, depending on the size and type of chunks of dataset documents are parsed into. Embeddings can be used to represent and organize the dataset documents within a high-dimensional space (e.g., embedding space), where similar documents or concepts are located closer together. Embedding space can include a multi-dimensional vector space where each data point is represented by an embedding.

ML trainers 184 can include any combination of hardware and software for training ML models 182. These trainers 184 can use datasets comprising queries 106 and form entries 134 to train the models 182. For example, the datasets can include various tax forms such as Form W-2, Form W-3, and Form W-4, which include entries related to employee income, tax withholdings, and other payroll-related data. These trainers 184 can use datasets comprising queries 106 and form entries 134 to train the models 182. For example, an ML trainer 184 can train an ML model 182 to identify errors 162 in payroll form entries 134 and generate proposed corrections 164. ML trainers 184 can be managed by ML frameworks 180 and utilized by the data processing system 120 to enhance its operations. These trainers 184 can retrain the ML models 182 using updated data from the database 202 of the example system 200 to ensure that ML models 182 remain accurate and effective.

Through training, the generative AI model 182 can learn, or adjust its understanding of mapping the embeddings to particular issues (e.g., prompts related to resource availability or constraints concerning the resources), by adjusting its internal parameters. For example, the model can be trained using datasets comprising various tax forms such as Form W-2, Form W-3, and Form W-4, which contain entries related to employee income, tax withholdings, and other payroll-related data. Internal parameters can include numerical values of the generative AI model 182 that the model learns and adjusts during training to optimize its performance and make more accurate predictions. Such training and can include iteratively presenting the various data chunks or documents of the dataset (e.g., or their chunks, embeddings) to the generative AI model 182, comparing its predictions with the known correct answers, and updating the model's parameters to minimize the prediction errors. By learning from the embeddings of the dataset data chunks, the generative AI model 182 can gain the ability to generalize its knowledge and make accurate predictions or provide relevant insights when presented with prompts 152.

The generative AI model 182 can include any ML or AI model or a system that can learn from a dataset to generate new content (e.g., text or images) that resembles a distribution of the training dataset. A distribution of a dataset can include an underlying probability distribution representing the patterns and characteristics of the data used to train a generative AI model 182. For example, a training data distribution can represent statistical properties of a text data (e.g., text corpus), such as the frequency of words, the co-occurrence of terms, and the overall structure of the language used in the training dataset. The generative AI model 182 can include the functionality to utilize such a probability distribution of patterns and characteristics to generate new responses (e.g., predictions) that were not present in the dataset. For example, the generative AI model 182 can be trained on a dataset of tax forms, such as Form W-2, Form W-3, and Form W-4, to generate accurate responses to queries related to tax entries, tax withholdings, and other payroll-related data.

The network 101 can be a wireless or wired connection for connecting and allowing the data processing system 120 with other components of system 100. The network can include a hardwired connection (e.g., copper wire or fiber optics) or a wireless connection (e.g., wide area network (WAN), controller area network (CAN), local area network (LAN), or personal area network (PAN)). The network 101 can include Wi-Fi, Bluetooth, BLE, or other communication protocols for transferring over networks as described herein. The network can include the Internet, intranet or any combination of wired and wireless links and connections allowing data communication.

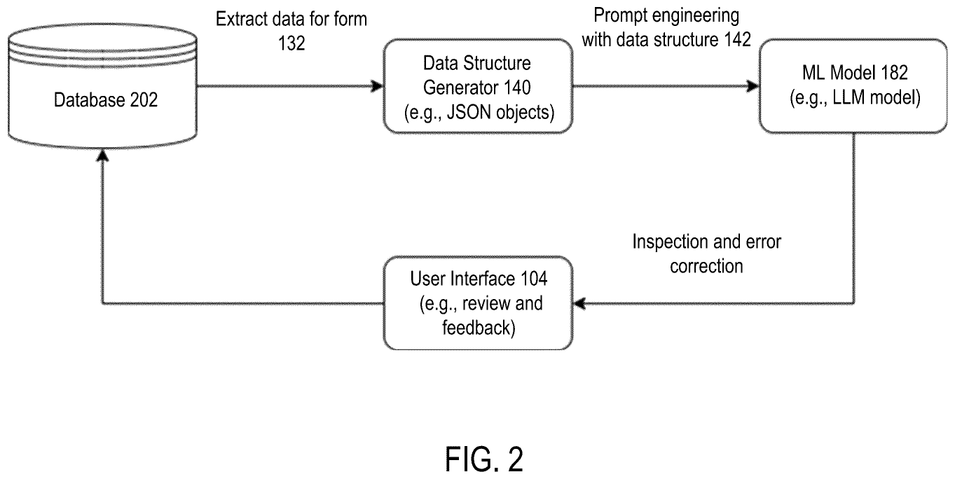

FIG. 2 illustrates an example of a system 200 for providing tax inspection and assistance and user query responses (e.g., answers to user questions) using an ML model. The system 200 can be utilized within or along with the example system 100 of FIG. 1. System 100 can include a database 202 for storing data (e.g., tax form information), a data structure generator 140 for generating JSON objects, an ML model 182 (e.g., a generative artificial intelligence model, a large language model (LLM) model or a transformer neural network model) and a user interface 104 for providing review and feedback. An LLM can typically refer to an ML or AI model trained on a vast amount of text data, often comprising billions of parameters, which allows it to understand and generate human-like text with high accuracy. In contrast, medium or small language models are trained on smaller datasets and have fewer parameters, typically ranging from millions to tens or hundreds of millions, resulting in less accurate and less comprehensive text generation capabilities. System 200 can be a system for providing ML model-based tax inspection to help clients and their employees detect and correct errors in their tax forms. System 200 can be used to identify, correct or prevent errors in the tax forms from being delivered to clients and their employees. System 200 can be used to help clients and their employees answer specific tax-related questions based on their W-2 forms.

Database 202 can store any type of data, which can be accessed or utilized by any component of the data processing system 120, including ML trainer 184 and data structure generator 140. Database 202 can store various employee or enterprise data that can be used for populating or generating any type of forms, such as payroll, tax, business, government or human resources forms. For example, the data of the database 202 can include information found within the W-2 form and other similar tax forms, including a wide array of data points, such as personal employee data, including employee's name, address, and social security number and/or employer data, such as employer's identification number (EIN). The data stored in the database 202 can include financial information, including employee's total wages, tips, and other types of compensation, as well as federal income tax amount withheld, social security wages and the corresponding tax deductions, as well as equivalent figures for Medicare wages and taxes withheld. State-specific data can include state income tax withholdings to particulars related to state wages, tips, and more. The stored data can include insights into local income tax withholdings, corresponding local wages and tips, and noteworthy adjustments to income. The data can include contributions to plans such as 401(k), alongside benefits tied to dependent care and other categories. The forms may involve alphanumeric codes paired with specific monetary values, pertinent to various items like health insurance premiums and nonqualified plans, among other relevant components.

The data stored in the database 202 can be accessed, used or incorporated by the ML model within an ML trainer 184 for training and testing of the ML models 182, as well as for prompt information, or any other functionality of the data processing system 120. For instance, the stored data encompasses or identifies elements like the project model's purpose, scope, anticipated outcomes, and potential impacts. The data can delve into performance metrics and evaluation criteria, outlining anticipated output ranges or values for specific form fields, such as salary brackets or withheld taxes. For instance, the data can correspond to ethical, legal, and regulatory considerations related to ML model usage are covered, along with risk evaluation and mitigation strategies. The roles and responsibilities of stakeholders throughout development, deployment, and upkeep can be specified in the data, alongside documentation standards, communication practices, quality assurance procedures, and validation protocols. The model's feedback mechanisms and performance monitoring strategies can be addressed using the data stored in the database 202.

System 200 can include and incorporate real-world data and feedback to improve the accuracy and reliability of the ML models 182 via iterated process. For instance, once utilized by the data processing system 120, the forms, entries, values, queries and responses can each be stored in the data that can be used for iterative and updated training of ML models 182 to improve their performance with continued use. For example, ML models 182 can be fine-tuned by the ML trainers 184 for specific tax domains and scenarios (e.g., specific tax brackets, types of employee positions, industries, salary ranges and other information).

System 200 can include a user interface 104 that is a graphical user interface (GUI) that can allow the user to communicate with the ML model 182 (e.g., an LLM) so as to receive natural language inputs, questions or prompts from the user of the client device 102 and then provide responses 172 to such queries 106 back to the GUI. The GUI can include or operate along with an application allowing the user of the client device 102 to enter inputs (e.g., characters forming the query 106), which can be converted by the system into formats readable by the data processing system components, such as the ML model 182.

The user interface 104 (e.g., the GUI) can include a search bar for the user to search journey pages, contents and for users (e.g., employees) to ask questions about payroll, tax, and other aspects of tax preparation. The search bar can allow the users to search database information. Database 202 can include and store numerous (e.g., tens of thousands or hundreds of thousands) of documents on taxes, such as any help and support articles, compliance, poster, policies. Search engine can help clients find the correct content accurately and efficiently.

For example, system 200 can include features and functions for searching data, such as search and intelligence services powered by natural language processing (NLP) or other ML functionalities to provide search capabilities for applications and websites. For example, system 200 can include third party search functions leveraging ML-based intelligent search services powered by NLP and ML functionalities.

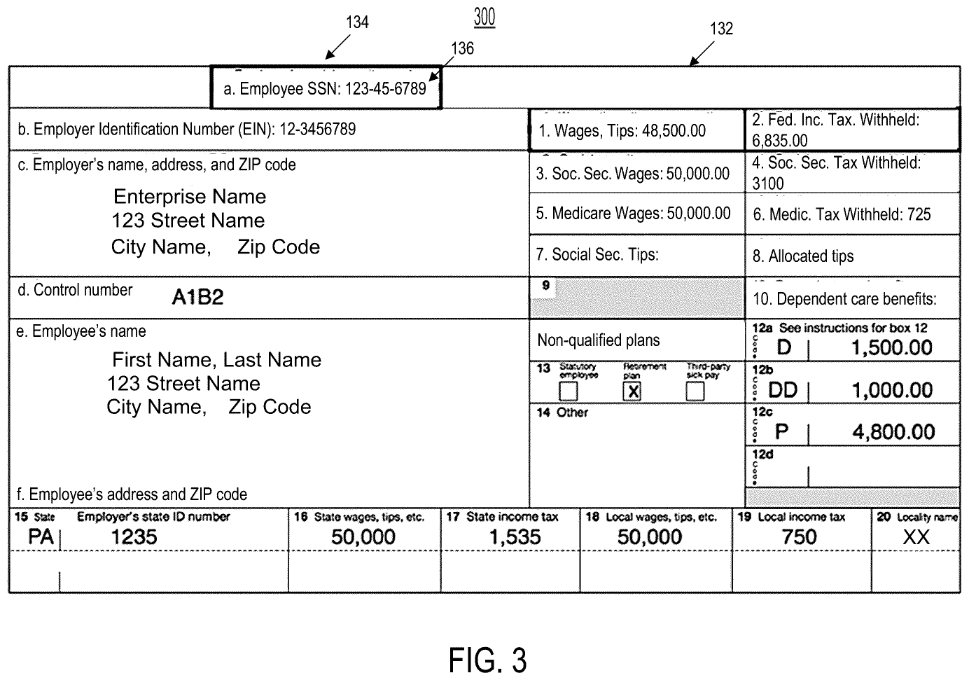

FIG. 3 illustrates an example form 132 having entries 134 containing values 136, which can be provided for analysis by the data processing system 120 and its ML models 182. The form 132 can include any type of form of a form, such as a tax form (e.g., a W-2 or an IRS 1040 form) filled out for a particular employee of a company or a tax form for an enterprise (e.g., a corporation or a business). The form 132 can include a loan application form (e.g., a mortgage application or a personal loan), an immigration form (e.g., visa application or a green card application), a healthcare form (e.g., insurance claim, or a medical history form), an application for attending an academic institution (e.g., a college admission form, financial aid form), a job application (e.g., resume, employment history), a legal form (e.g., a contract, a power of attorney, a rental lease form), a government benefits form (e.g., social security forms or unemployment forms), a vendor registration form (e.g., a supplier information, biding form, financial transactions forms), real estate form (e.g., purchase and sales agreement) or any other type and form of a form.

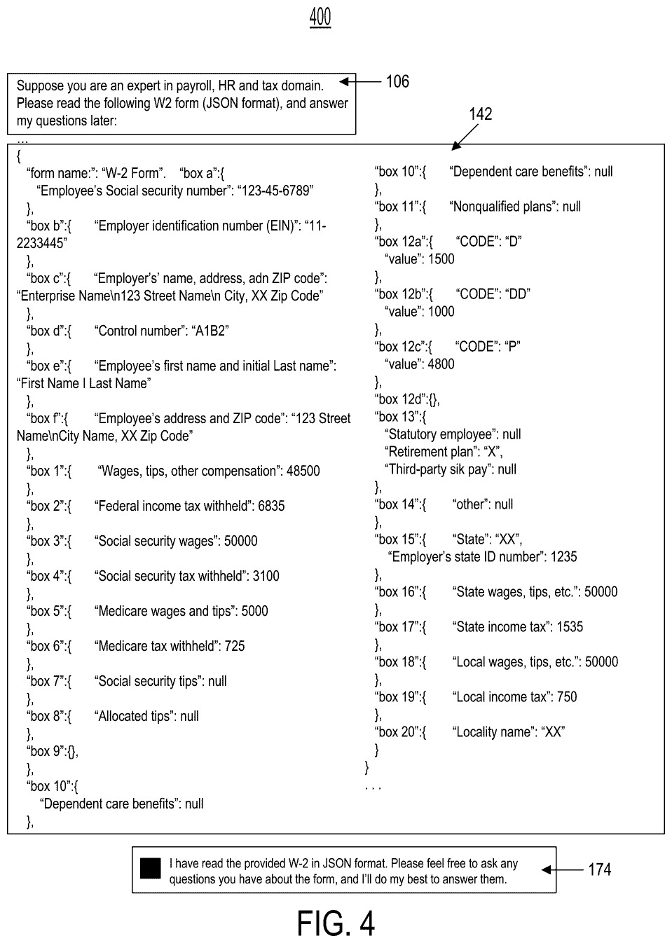

Example form 132 can include various entries 134, such as entries “a.” through “e.” corresponding to employee's social security number, employer identification number, employer's name and address, control number and employee's name and address. These entries 134 can each include their own values 136 providing characters (e.g., letters, numbers and symbols) providing specifics about each of the entries 134. The form 132 can be provided, for analysis and inspection, to the ML model trained on a data set of a particular type of form, such as for example, tax forms and tax related data, as illustrated in FIG. 3. In the instances in which other types of forms (e.g., for different fields, such as healthcare, legal form or a loan application form), the ML model can be trained on the dataset for that respective particular field (e.g., healthcare dataset in the case of healthcare form analysis, legal dataset in the case of legal form analysis, loan dataset in the case of loan form analysis or any other types of datasets for any types of forms). To utilize an ML model, a prompt function can be utilized. For example, a prompt function can receive a tax form and convert it to a prompt. The prompt can include a data structure. Data structure can include one or more JSON objects, such as an object illustrated in FIG. 4.

FIG. 4 can illustrate an example of a data structure 142, such as an example JSON object, generated for a form 132 of FIG. 3 (e.g., a JSON data structure for a tax form). Data structure 142 (e.g., JSON object) can be generated and presented along with a query 106 for input into the ML model 182. Data structure 142 can include any number of entries for any number of inputs for the form (e.g., values, character strings or other entries). For example, a JSON object can identify an employer and an employee by name and address. The address can include the street address, the zip code, the city name and the state. The form can include an entry identifying the employee's social security number, employee's amount of wages, tips and other compensation, social security wages, Medicare wages and tips, amount of federal income tax withheld, social security tax withheld and Medicare tax withheld. Example form 132 and the corresponding JSON object 142 can include or identify employer's state ID number, state wages, state income tax, local wages, tips, local income tax as well as other entries and selections.

The example form 132 and/or data structure 142 (e.g., JSON object) can include one or more errors 162, such as typographical errors, inconsistencies or mistakes input in the entries of the form 132. For example, in the first line of JSON object: “form name: ”: “W-2 Form” can include an addition (e.g., repetitive) colon inside the quote. For example, in the box “c”, “Employer's' name, address, adn ZIP code”, there can be a typo “adn” which corresponds to the word “and”. For example, in the box 13: “Third-party sik pay”, a typo “sik” can be included, which should correspond to “sick”. In the box 5: “5000”, a typo as to the amount “5000” can be directed to “50000”. The data processing system 120 can provide proposed corrections 164 to such errors 162, fixing the values 136, typos or format-related issues. An explanation 174 can be provided in the context of the information presented.

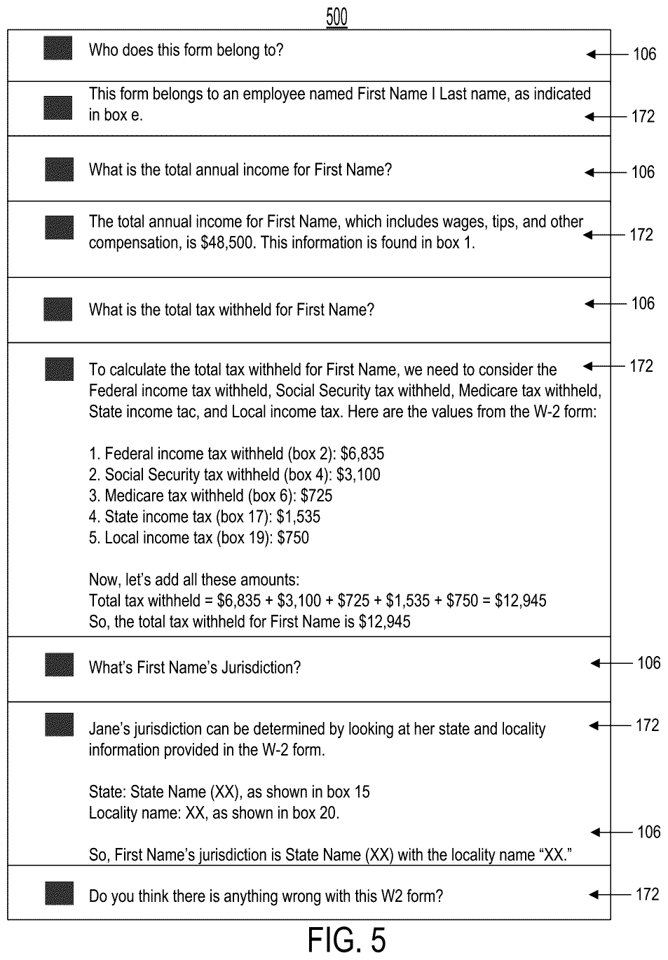

FIG. 5 illustrates an example 500 of exchanges of queries 106 from a client device 102 and responses 172 from a data processing system 120 utilizing the ML models 182 to provide responses via the interfaces 104 and 130. In example 500, the client device 102 can provide various queries 106 including different questions on various details of a tax form 132 via a graphical user interface (GUI) 104 of the client device 102. The data processing system 120 can utilize one or more ML models 182 to provide one or more responses 172 to each of the questions of the queries 106. For instance, example 500 can facilitate the user to ask the ML model 182 questions on employee name on the W-2 form, the annual income for the employee, the total tax withheld and the jurisdiction for this employee.

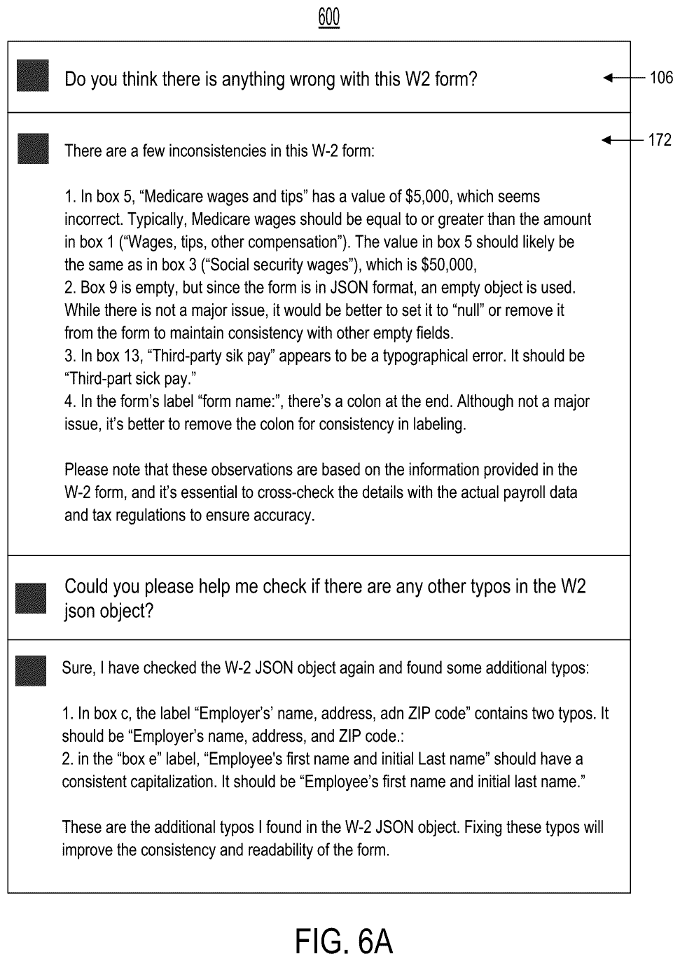

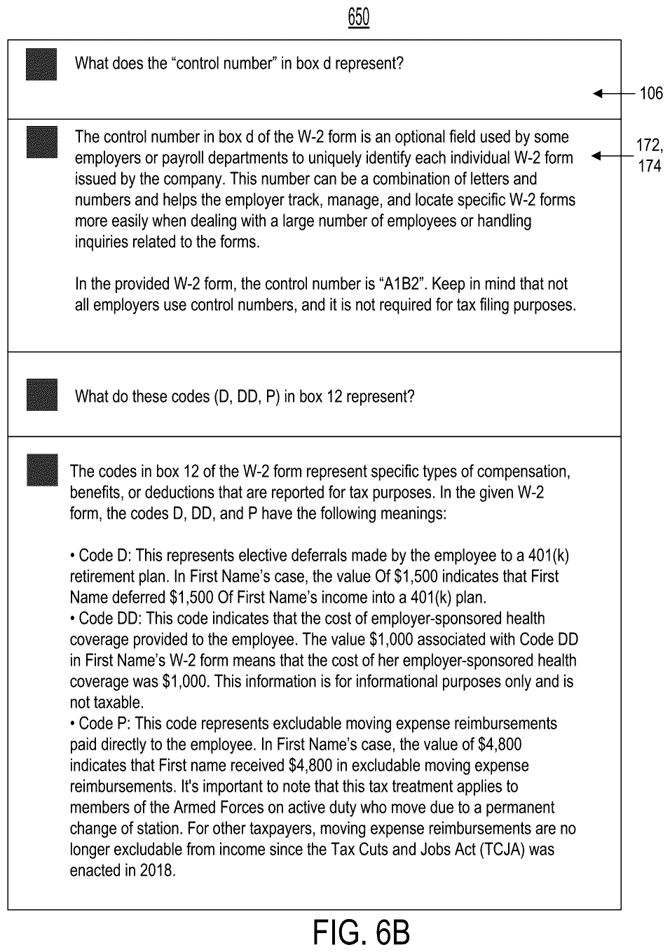

FIG. 6A illustrates an example of communication exchange 600 including queries 106 and responses 172 with respect to inconsistencies or errors 162 with respect to the form 132. For example, communication exchange 600 can include questions or prompts about any errors (e.g., typos) in the tax form. The ML model 182 can provide answers to the user questions, which can be provided to the user via the GUI. For example, in response to a question about any inconsistencies, ML model can identify the typo in box 5, due to the large amount of training data used to train the AI model and the prompt message instruction triggering the ML model to identify the typos and inconsistencies. As a result, responsive to the prompts, the AI model can behave like a real tax expert to tell users why the ML model believed the value “$5000” in box 5 seemed wrong.

FIG. 6B illustrates an example of communication exchange 650 of queries 106 and responses 172 in which a user requests explanations on particular portions of the form 132 and ML model provides response explanations (e.g., 174) explaining the requested portions of the form. For example, communication exchange 650 can include a user query on the specific meaning of some codes and terminology, e.g., the meaning of “control number” for box d, the meaning of codes “D”, “DD” and “P” for the particular box in the code.

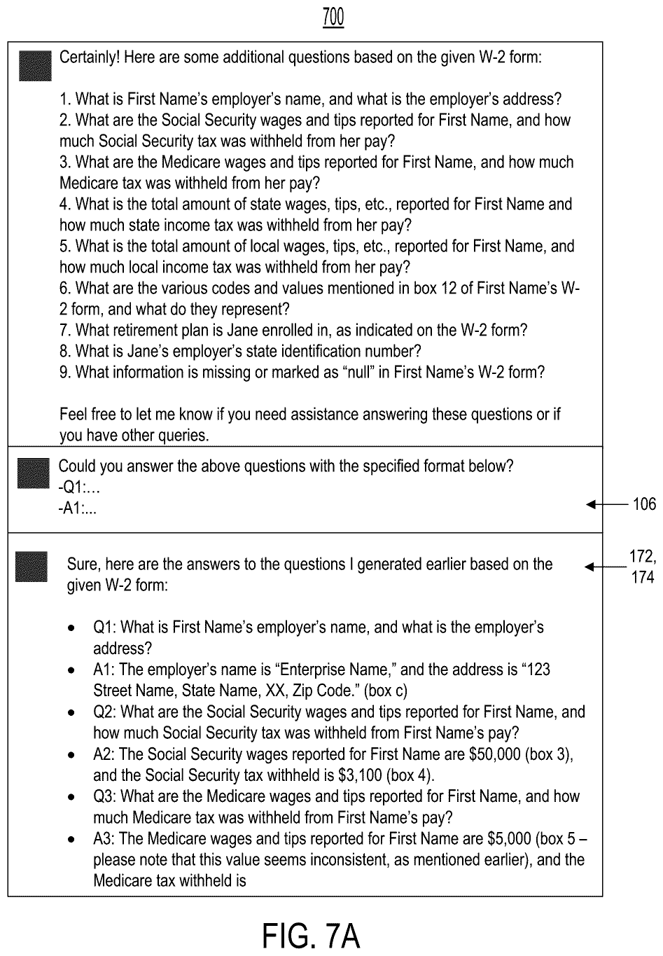

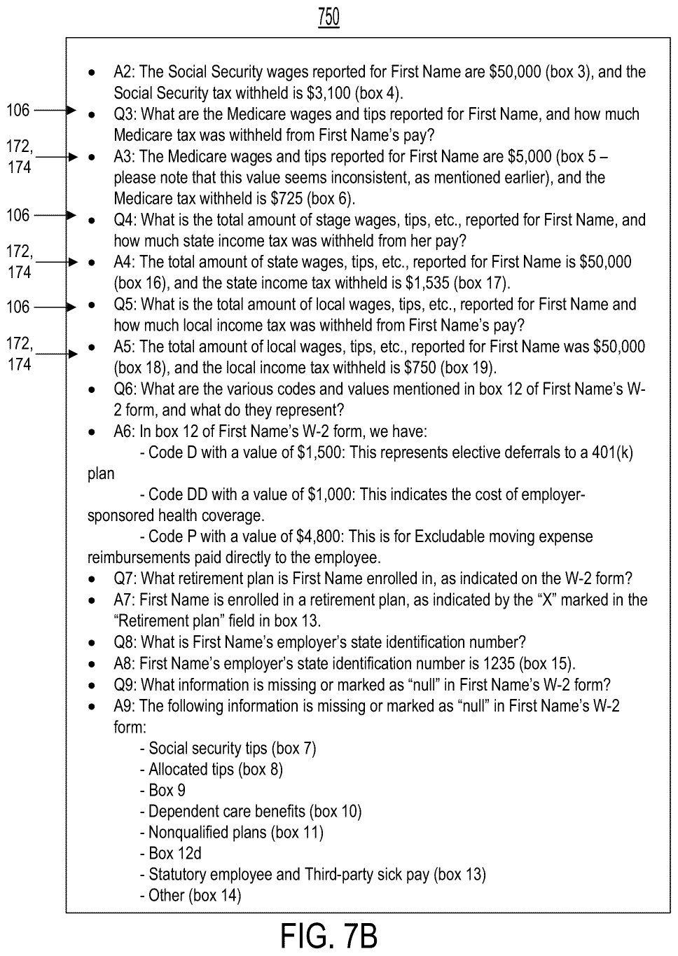

FIGS. 7A-7B illustrate examples of communication exchanges 700 and 750 of queries 106 and responses 172 involving questions that ML model can ask and answers in response to a user request. For example, a user can ask the ML model to generate some questions based on the given W-2 form and answer them with the required format. The ML model can provide a list of questions and answer the questions in a particular format.

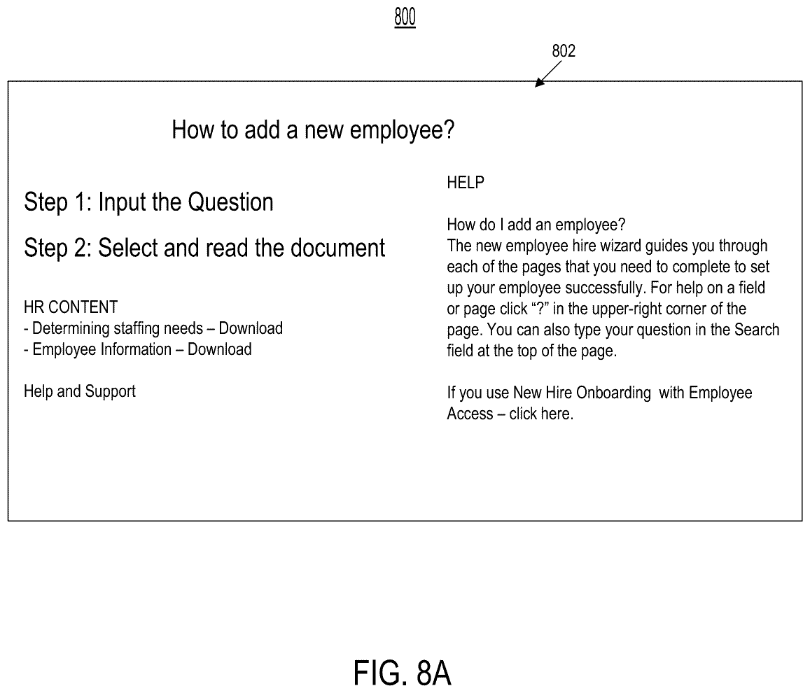

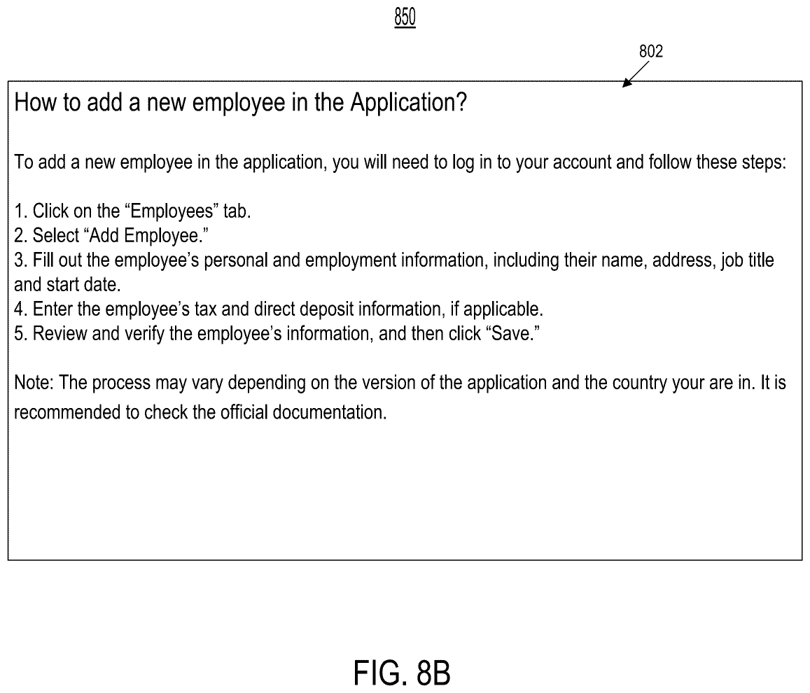

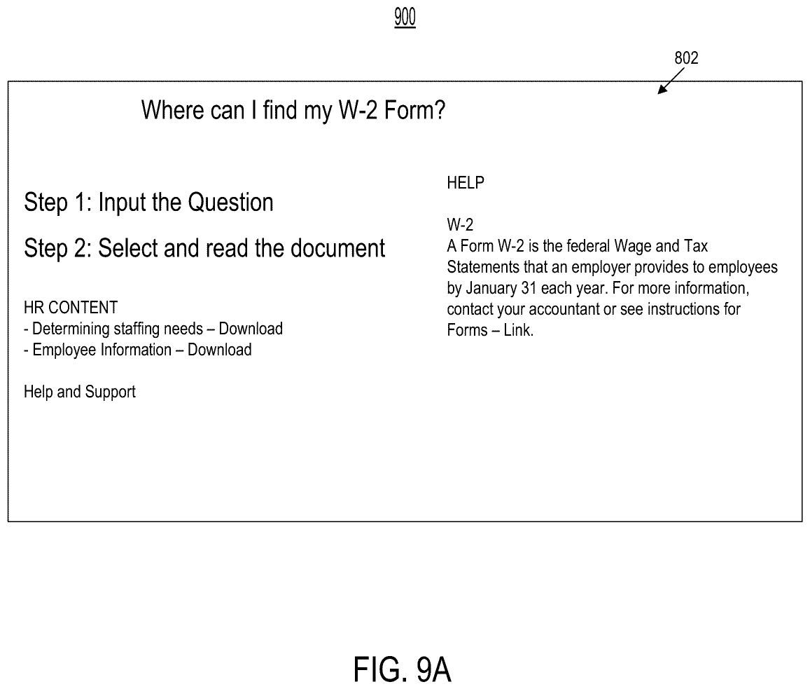

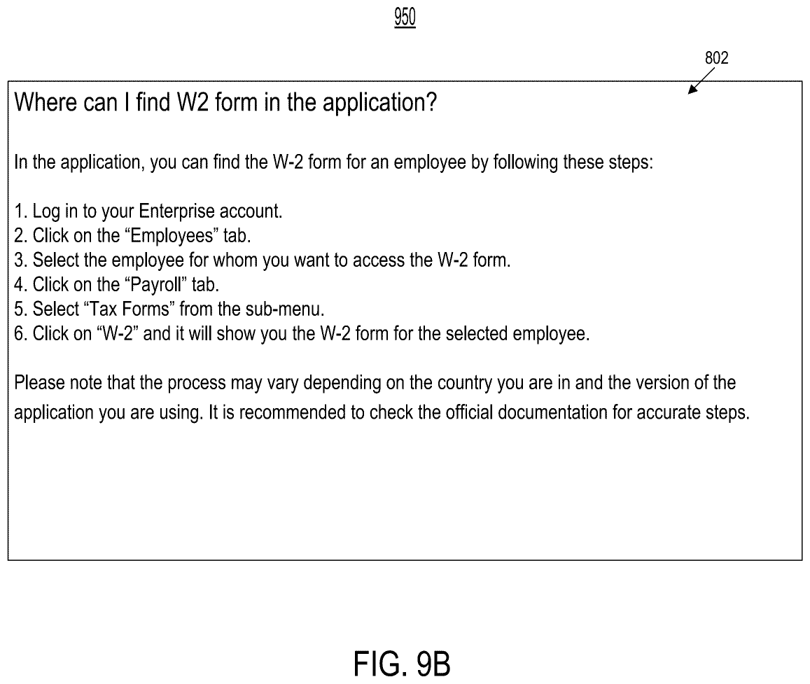

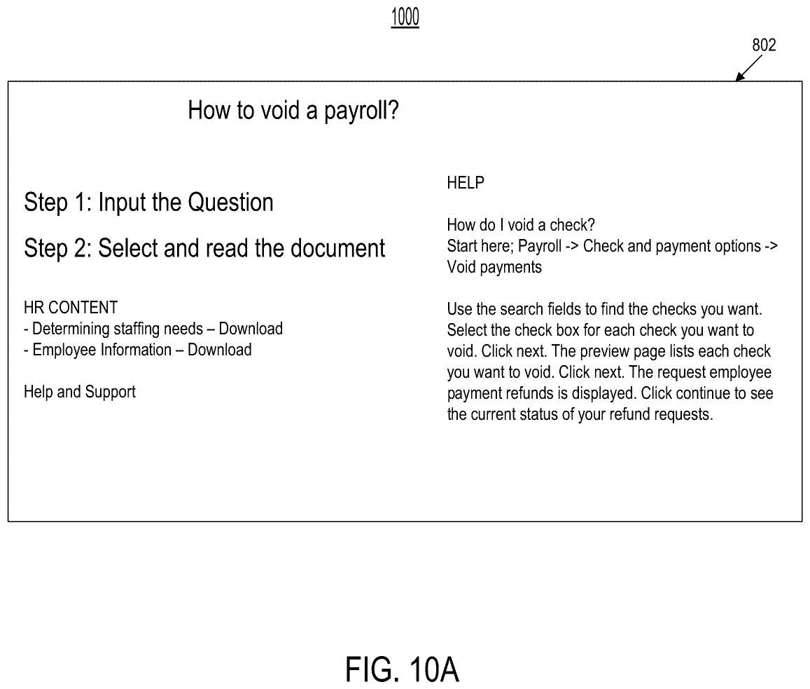

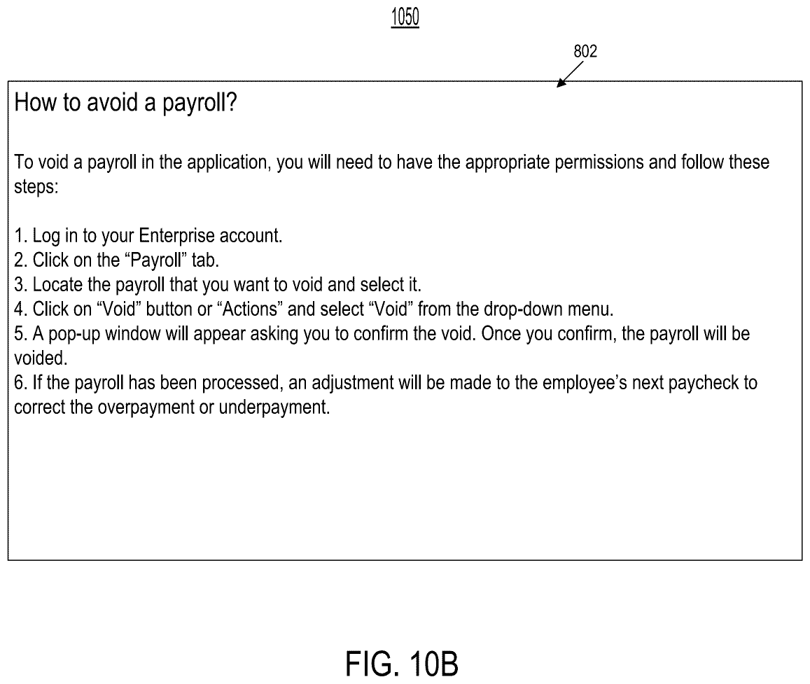

FIGS. 8A-10B illustrate examples of screenshots 800, 850, 900, 950, 1000 and 1050 of windows 802 utilizing application interface for searching data using ML. FIGS. 8A-8B illustrate example screenshots 800 and 850 of windows 802 for user interface 104 for searching for directions to add a new employee to a system. FIGS. 9A-9B illustrate example screenshots 900 and 950 of windows 802 for searching for directions to find an employee's own tax form (e.g., W2) on the system. FIGS. 10A-10B illustrate example screenshots 1000 and 1050 of windows 802 for searching for directions to find a way to void a payroll.

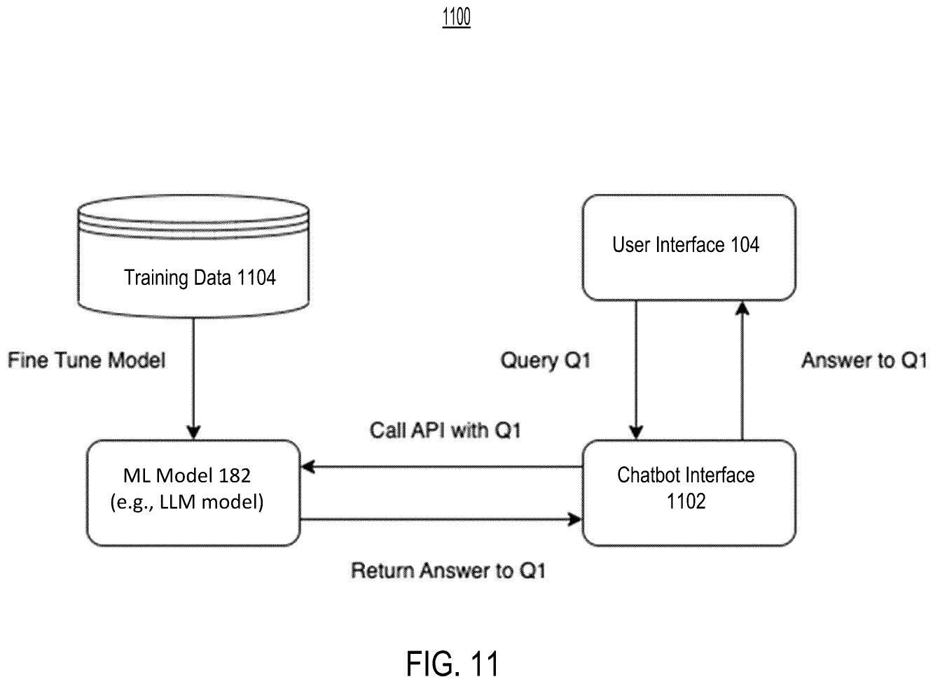

FIG. 11 illustrates an example system 1100 for training or retraining the ML models 182 of the technical solutions using chatbot functionalities that can be incorporated into and utilized by the data processing system 120. The example system 1100 can be combined with or used alongside any features of example systems 100 or 200, and vice versa. System 1100 can include a training data (e.g., tax data stored in a database) that can be used to fine tune or train an ML model 182 (e.g., LLM model). A chatbot interface 1102, can be an interface component of the interface 130 or the user interface 104 for utilizing ML models 182 to generate communications and responses to user queries 106 within the context of the questions. The chat question/answer (Q/A) user interface (UI) 1102 can be used to send an application programming interface (API) call with the first question to the ML model (e.g., call API with Q1) which can be provided by the UI in response to a receive query (e.g., Q1) from the user. In response to the first question being received, the ML model can respond with a return answer (e.g., return answer to Q1). The return answer can include a text message or an API call to the chat Q/A UI. Then the chat Q/A UI 1102 can provide the answer to the user

For example, system 1100 can be trained with a dataset of training data 1104 that can include thousands of help and support articles (e.g., 5k to 10k documents), site contents (e.g., 800-5000 documents) and thousands of HR documents (e.g., 10k-100k). System 1100 can train ML models 182 using the training data 1104. The training data 1104 can include any data stored in a database 202. The training data 1104 can be utilized for prompt engineering. For example, prompt engineering for ML models 182 can include the construction of high-quality training data that can include prompt-completion pairs. For instance, an ML model 182 can utilize a JSON or JSONL file format, characterized by the structure: {“prompt”: “<prompt text>”, “completion”: “<ideal generated text>”}. Such an approach can improve the precision of fine-tuning efforts. For instance, an exemplar question, “How to add a new employee?”—can provide a corresponding prompt-completion pair is structured as follows: {“prompt”: “How to add a new employee?”, “completion”: “You have the option to onboard your employee or let themselves onboard through a user interface. Start here: People >Add new employee (W2) Select the way you want your employee to onboard . . . ”} This format can allow for clear communication between the desired prompt and its intended completion in terms of AI model training.

The queries 106 (e.g., questions or user prompts) and responses 172 (e.g., completions or answers) can be provided or generated by user. To convert the data into the desired format, the solutions can utilize different ways. For instance, the system can include collecting the possible questions from users search string history and the corresponding destination link/page the users clicked. User can use a generative AI model's APIs to create questions/answers based on the content (e.g. H&S article) with human reviews. The system can include any number of tokens, where a token can include approximately 0.75 words. For instance, 1000 tokens can correspond to about 750 words.

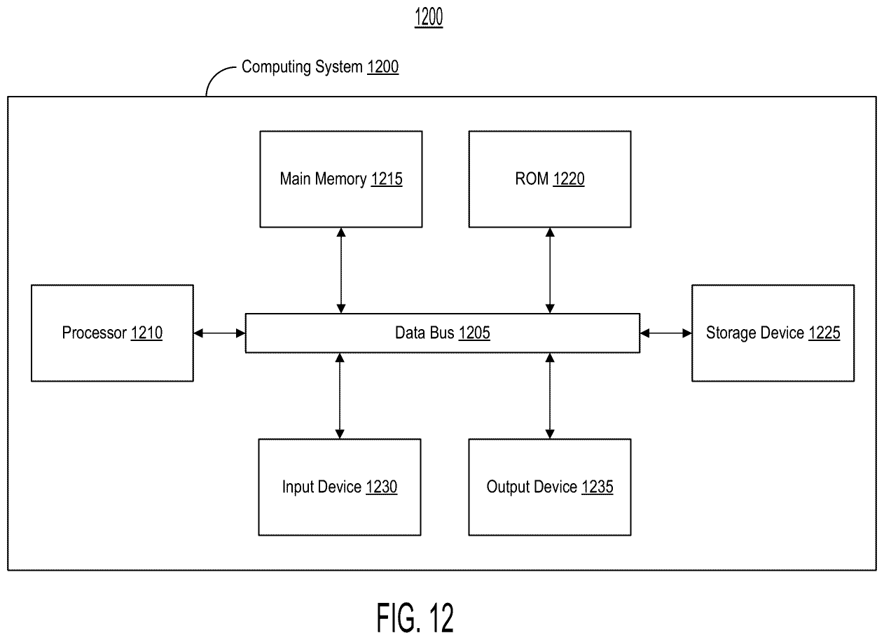

FIG. 12 illustrates a block diagram of a computing system for implementing the embodiments of the technical solutions, in accordance with embodiments. FIG. 12 illustrates a block diagram of an example computing system 1200, which can also be referred to as the computer system 1200. Computing system 1200 can be used to implement elements of the systems and methods described and illustrated herein, such as for example, commands, instructions or data described herein. Computing system 1200 can be included in and run any system or device, such as a system 100 of FIG. 1, system 200 of FIG. 2 or system 1100 of FIG. 11. The computing system 1200 can be utilized to provide a data processing system 120 an ML model 182, a client device 102, a payroll processing system 110, or any other component of any system or feature herein.

Computing system 1200 can include at least one bus data bus 1205 or other communication device, structure or component for communicating information or data. Computing system 1200 can include at least one processor 1210 or processing circuit coupled to the data bus 1205 for executing instructions or processing data or information. Computing system 1200 can include one or more processors 1210 or processing circuits coupled to the data bus 1205 for exchanging or processing data or information along with other computing systems 1200. Computing system 1200 can include one or more main memories 1215, such as a random access memory (RAM), dynamic RAM (DRAM), cache memory or other dynamic storage device, which can be coupled to the data bus 1205 for storing information, data and instructions to be executed by the processor(s) 1210. Main memory 1215 can be used for storing information (e.g., data, computer code, commands or instructions) during execution of instructions by the processor(s) 1210.

Computing system 1200 can include one or more read only memories (ROMs) 1220 or other static storage device 1225 coupled to the bus 1205 for storing static information and instructions for the processor(s) 1210. Storage devices 1225 can include any storage device, such as a solid state device, magnetic disk or optical disk, which can be coupled to the data bus 1205 to persistently store information and instructions.

Computing system 1200 may be coupled via the data bus 1205 to one or more output devices 1235, such as speakers or displays (e.g., liquid crystal display or active matrix display) for displaying or providing information to a user. Input devices 1230, such as keyboards, touch screens or voice interfaces, can be coupled to the data bus 1205 for communicating information and commands to the processor(s) 1210. Input device 1230 can include, for example, a touch screen display (e.g., output device 1235). Input device 1230 can include a cursor control, such as a mouse, a trackball, or cursor direction keys, for communicating direction information and command selections to the processor(s) 1210 for controlling cursor movement on a display.

The processes, systems and methods described herein can be implemented by the computing system 1200 in response to the processor 1210 executing an arrangement of instructions contained in main memory 1215. Such instructions can be read into main memory 1215 from another computer-readable medium, such as the storage device 1225. Execution of the arrangement of instructions contained in main memory 1215 causes the computing system 1200 to perform the illustrative processes described herein. One or more processors 1210 in a multi-processing arrangement may also be employed to execute the instructions contained in main memory 1215. Hard-wired circuitry can be used in place of or in combination with software instructions together with the systems and methods described herein. Systems and methods described herein are not limited to any specific combination of hardware circuitry and software.

Although an example computing system has been described in FIG. 12, the subject matter including the operations described in this specification can be implemented in other types of digital electronic circuitry, or in computer software, firmware, or hardware, including the structures disclosed in this specification and their structural equivalents, or in combinations of one or more of them.

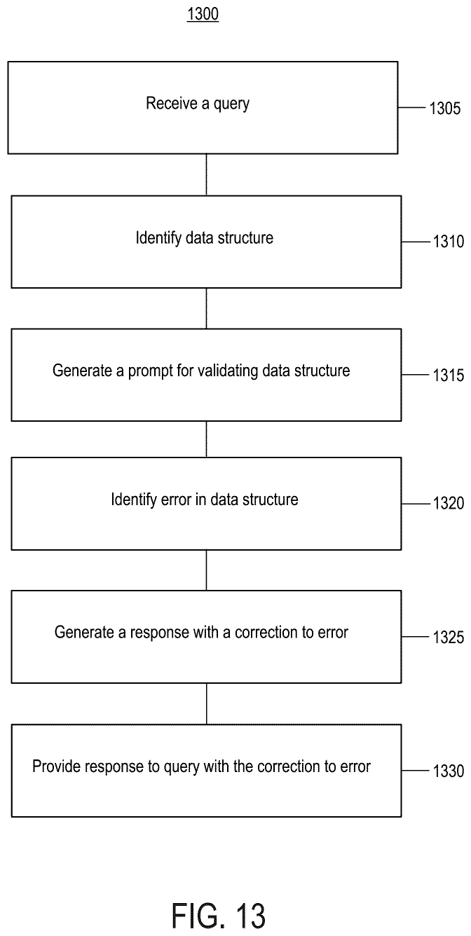

FIG. 13 shows a flow diagram of a method for providing validated responses to form specific user queries using machine learning, in accordance with embodiments of the present solution. Method 1300 can be implemented using the system tools, devices and components discussed in FIGS. 1-12, including a computing environment 1200 providing processors 1210 that can be configured using instructions, computer code and data stored in memories 1215, 1220, or 1225 to configure or cause the processors 1210 to perform acts or operations of the method 1300.

Method 1300 can include acts or operations 1305-1330. At act 1305, the method can receive a query. At act 1310, the method can identify a data structure. At act 1315, the method can generate a prompt to validate the data structure. At act 1320, the method can identify errors in the data structure. At act 1325, the method can generate a response with a correction to the error. At act 1330, the method can generate a response to query with the correction to the error.

At act 1305, the method can receive a query. The method can include a data processing system comprising one or more processors coupled with memory receiving a query corresponding to an entry of a form. The one or more processors can receive the query via a user interface of a client device, such as a graphical user interface. The one or more processors can receive the query via an interface of the data processing system. The query can indicate, mention, or discuss features, components, or portions of a form, such one or more entries of a form.

The form can be any type of a form, such as a Form W-2, Wage and Tax Statement, a Form W-3, Transmittal of Wage and Tax Statements, or Form W-4, Employee's Withholding Certificate. The form can be a Form 1099, Miscellaneous Income, a Form 940, Employer's Annual Federal Unemployment (FUTA) Tax Return, or a Form 941, Employer's Quarterly Federal Tax Return. The form can be any type of a form, such as a Form 1040, U.S. Individual Income Tax Return, a Form 4506-T, Request for Transcript of Tax Return, or a Form 8962, Premium Tax Credit (PTC).

The entry of the form can be any entry of any of the forms, such as an employee's total annual income on a Form W-2, the federal tax withheld on a Form W-3, or the number of allowances claimed on a Form W-4. The entry can include the miscellaneous income amount on a Form 1099, the FUTA tax amount on a Form 940, or the quarterly tax liability on a Form 941. The entry can include, for example, the adjusted gross income on a Form 1040, the requested transcript type on a Form 4506-T, or the premium tax credit amount on a Form 8962. Other examples can be the dependent care benefits on a Form W-2, the employer's identification number on a Form W-3, or the employee's withholding allowance on a Form W-4.

The method can include receiving the form comprising the entry corresponding to at least one of: a name of an enterprise, a name of one of an employee or a contractor, an address, an amount of annual income, an amount of tax deduction, an amount of tax credit, or an amount of tax withheld. The method can include a processor identifying, within the form for a tax operation, a plurality of entries comprising the entry. The plurality of entries can correspond to tax data associated with an electronic account of one of an enterprise or an employee of the enterprise. The method can include the processor receiving the query via an application programming interface (API) call generated responsive to a request from a client device for an explanation of a value of the entry of the form for a payroll process.

At act 1310, the method can identify a data structure. The method can include the one or more processors identifying a data structure indicative of a plurality of entries of the form. The method can include a data structure generator utilizing an ML model trained to generate a data structure in a JSON format to generate a JSON object that includes or references entries of the form. The data structure generator can generate values indicating the characteristics or properties (e.g., values, amounts or selections) of the entries of the form at the JSON object. For example, the data structure generator can create a JSON object that includes entries for employee name, address, and social security number. The data structure generator can also generate values for entries such as total annual income, federal tax withheld, and state tax withheld. The data structure generator can include entries for dependent care benefits, retirement plan contributions, and additional Medicare tax.

The data structure can be configured as a JavaScript object notation (JSON) object for input into the one or more ML models. Other than the JSON object, the data structure can be configured as an XML object, a YAML object, a BSON object, a MessagePack object, a Protobuf object, an Avro object, a Thrift object, a CSV object, a Parquet object, or an ORC object. The method can include the data structure generator generating the data structure that indicates a plurality of values for the plurality of entries, based on the form.

At act 1315, the method can generate a prompt to validate the data structure. The method can include the one or more processors generating a prompt to validate the plurality of entries using the data structure. The prompt can be generated based on the characteristics or properties of the entries indicated in the data structure, such as the employee's name, total annual income, federal tax withheld, and state tax withheld. The prompt can include instructions or data to direct or instruct the one or more ML models to validate the data structure (e.g., using the validator).

The method can include the one or more processors utilizing the prompt to identify any discrepancies or errors in the entries. The prompt can be used to cross-check the values of the entries against predefined rules or criteria. The method can include the one or more processors updating the data structure based on the validation results from the prompt.

At act 1320, the method can identify error in the data structure. The method can include the one or more processors identifying an error in an entry of the plurality of entries of the form. The method can include identifying the error in the entry, based on the prompt and the data structure input into one or more ML models. The one or more ML models can be trained using a dataset stored in a database. The dataset in the database can include a plurality of queries for a plurality of forms that have a plurality of entries. The dataset can include results of various payroll processes executed by the payroll processing system to compute various values for various entries of various forms.

The method can include validating the data structure or any portion of the data structure (e.g., one or more entries or their respective values) using the validator utilizing one or more ML models. The validator can validate the entries of the data structure by utilizing API functions to issue API calls to the payroll processing system to execute payroll processes or operations that are used or configured to compute or determine particular values for the particular entries. For instance, the validator can utilize ML models to trigger a payroll process for computing a value for a total annual income entry, a value for a federal tax withheld entry, or a value for a state tax withheld entry, based on other values or entries of the one or more forms associated with the same entity (e.g., the same employee or enterprise). The values determined by the payroll processes can then be compared with the values of the entries in the data structure to determine if they match or not match. If the values determined by the payroll processes do not match, the validator can determine that there is an error in those particular entries. If the values determined by the payroll do match, the validator can determine that the data structure is correct and validated and no error is identified.

For any errors identified, the validator can utilize the one or more ML models or one or more payroll processes (e.g., via payroll processing system) to determine the correct values for the entries. Those corrected or computed values can be designated as the proposed corrections. The method can include validating the response, based at least on the proposed correction, the entry and the data structure input into the one or more ML models. For instance, the ML model can determine that the response to be provided to the client device is validated in response to inputting the proposed correction, the entry data and the data structure into the ML model to evaluate if the proposed correction produces a valid data structure (e.g., with no errors). In response to determining that no errors are present, the ML model can determine that the data structure (e.g., with the proposed correction in the event that an error is identified) is valid.

At act 1325, the method can generate a response with a correction to the error. The method can include the one or more processors generating, based on the error and the data structure input into the one or more ML models, a response to the query comprising a proposed correction to the error in the form. The response generator can generate a textual response matching the context of the question in the query provided by the client device. The response generated can include or identify the error, provide any corrections and provide textual explanation of the corrections to any of the errors. For example, the response can indicate that there was an error in the federal tax withheld entry and provide a proposed correction that corrects this error, along with explanation describing why this correction fixes the error.

The method can include the one or more processors generating the response that can include the textual explanation of the entry of the form and the value of the entry. The response can be generated responsive to the API call that is generated responsive to a request from a client device for an explanation of a value of the entry of the form for a payroll process. The method can include generating the response identifying the error in the entry of the form.

At act 1330, the method can generate a response to query with the correction to the error. The method can include providing, for display via the user interface, the response to the query indicating the error and the proposed correction. The method can include providing the response for display via the user interface. The response can be provided responsive to the validation. The validation can be determined based at least on the proposed correction, the entry and the data structure input into the one or more ML models, the response. The one or more processors can display, via the user interface, the query followed by the response comprising the proposed correction and any explanations of the questions or issues raised in the query.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

The subject matter and the operations described in this specification can be implemented in digital electronic circuitry, or in computer software, firmware, or hardware, including the structures described in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order. Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently described systems or methods, their components, acts, or elements to single or plural configurations. References to any act or element being based on any information, act or element may include implementations where the act or element is based at least in part on any information, act, or element.

Any implementation described herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations described herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the described elements and operations without departing from the scope of the technical solutions described herein.

References to “approximately,” “substantially”, or other terms of degree include variations of +/−10% from the given measurement, unit, or range unless explicitly indicated otherwise. Coupled elements can be electrically, mechanically, or physically coupled with one another directly or with intervening elements. Scope of the Systems and methods described herein is thus indicated by the appended claims, rather than the foregoing description, and changes that come within the meaning and range of equivalency of the claims are embraced therein.

What is claimed is:

1. A system comprising:
a data processing system comprising one or more processors coupled with memory to:
receive, via a user interface, a query corresponding to an entry of a form;
identify a data structure indicative of a plurality of entries of the form;
generate, using the data structure, a prompt to validate the plurality of entries;
identify, based on the prompt and the data structure input into one or more machine learning (ML) models trained using a dataset comprising a plurality of queries for a plurality of forms having a plurality of entries, an error in an entry of the plurality of entries of the form;
generate, based on the error and the data structure input into the one or more ML models, a response to the query comprising a proposed correction to the error in the form; and
provide, for display via the user interface, the response to the query indicating the error and the proposed correction.

2. The system of claim 1, the one or more processors to:
validate, based at least on the proposed correction, the entry and the data structure input into the one or more ML models, the response; and
provide the response for display via the user interface, responsive to the validation.

3. The system of claim 1, the one or more processors to:
receive the query via an application programming interface (API) call generated responsive to a request from a client device for an explanation of a value of the entry of the form for a payroll process; and
generate, responsive to the API call, the response comprising textual explanation of the entry of the form and the value of the entry.

4. The system of claim 3, wherein the form corresponds to one of: a Form W-2, Wage and Tax Statement, a Form W-3, Transmittal of Wage and Tax Statements, or Form W-4, Employee's Withholding Certificate.

5. The system of claim 1, the one or more processors to:
identify, within the form for a tax operation, a plurality of entries comprising the entry, the plurality of entries corresponding to tax data associated with an electronic account of one of an enterprise or an employee of the enterprise; and
generate, based on the form, the data structure indicating a plurality of values for the plurality of entries.

6. The system of claim 1, wherein the data structure is configured as a JavaScript object notation (JSON) object for input into the one or more ML models.

7. The system of claim 1, the one or more processors to:
receive the form comprising the entry corresponding to at least one of: a name of an enterprise, a name of one of an employee or a contractor, an address, an amount of annual income, an amount of tax deduction, an amount of tax credit, or an amount of tax withheld.

8. The system of claim 1, the one or more processors to:
generate the response identifying the error in the entry of the form; and
display, via the user interface, the query followed by the response comprising the proposed correction.

9. A method comprising:
receiving, by one or more processors coupled with memory, via a user interface, a query corresponding to an entry of a form, the entry being one of a plurality of entries of the form;
generating, by the one or more processors, a prompt to validate the plurality of entries;
identifying, by the one or more processors, based on the prompt and one or more machine learning (ML) models trained using a dataset comprising a plurality of queries for a plurality of forms having a plurality of entries, an error in the entry of the plurality of entries of the form;
generating, by the one or more processors, based on the error and the data structure input into the one or more ML models, a response to the query comprising a proposed correction to the error in the form; and
providing, by the one or more processors, for display via the user interface, the response to the query indicating the error and the proposed correction.

10. The method of claim 9, comprising:
validating, by the one or more processors, the response based at least on the proposed correction and the entry; and
providing, by the one or more processors, responsive to the validation, the response for display via the user interface.

11. The method of claim 9, comprising:
receiving, by the one or more processors, the query via an application programming interface (API) call generated responsive to a request from a client device for an explanation of a value of the entry of the form for a payroll process; and
generating, by the one or more processors, responsive to the API call, the response comprising textual explanation of the entry of the form and the value of the entry.

12. The method of claim 11, wherein the form corresponds to one of: a Form W-2, Wage and Tax Statement, a Form W-3, Transmittal of Wage and Tax Statements, or Form W-4, Employee's Withholding Certificate.

13. The method of claim 9, comprising:
identifying, by the one or more processors, within the form for a tax operation, the plurality of entries corresponding to tax data associated with an electronic account of one of an enterprise or an employee of the enterprise; and
generating, by the one or more processors, based on the form, a data structure indicating a plurality of values for the plurality of entries.

14. The method of claim 9, further comprising generating a data structure configured as a JavaScript object notation (JSON) object for input into the one or more ML models, the data structure used to generate the prompt.

15. The method of claim 9, comprising:
receiving, by the one or more processors, the form comprising the entry corresponding to at least one of: a name of an enterprise, a name of one of an employee or a contractor, an address, an amount of annual income, an amount of tax deduction, an amount of tax credit, or an amount of tax withheld.

16. The method of claim 9, comprising:
generating, by the one or more processors, the response identifying the error in the entry of the form; and
displaying, by the one or more processors, via the user interface, the query followed by the response comprising the proposed correction.

17. A non-transitory computer-readable medium comprising instructions that, when executed by one or more processors, cause the one or more processors to:
receive, via a user interface, a query corresponding to an entry of a form;
identify a data structure indicative of a plurality of entries of the form;
generate, using the data structure, a prompt to validate the plurality of entries;
identify an error in an entry of the plurality of entries of the form based on one or more machine learning (ML) models using the prompt and the data structure;
generate, based on the error, a response to the query comprising a proposed correction to the error in the form; and
provide, for display via the user interface, the response to the query indicating the error and the proposed correction.

18. The non-transitory computer-readable medium of claim 17, wherein the instructions, when executed by one or more processors, cause the one or more processors to:
validate, based at least on the proposed correction, the entry and the data structure input into the one or more ML models, the response; and
provide, responsive to the validation, the response for display via the user interface.

19. The non-transitory computer-readable medium of claim 17, wherein the instructions, when executed by one or more processors, cause the one or more processors to:
receive the query via an application programming interface (API) call generated responsive to a request from a client device for an explanation of a value of the entry of the form for a payroll process; and
generate, responsive to the API call, the response comprising textual explanation of the entry of the form and the value of the entry, wherein form corresponds to one of: a Form W-2, Wage and Tax Statement, a Form W-3, Transmittal of Wage and Tax Statements, or Form W-4, Employee's Withholding Certificate.

20. The non-transitory computer-readable medium of claim 17, wherein the data structure is configured as a JavaScript object notation (JSON) object.
